(19) United States
(12) Patent Application Publication
(10) Pub. No.: US 2026/0330720 A1
(43) Pub. Date: Oct. 22, 2026

(54) DATA RESTRUCTURING TECHNIQUES FOR HIERARCHICAL DOCUMENT DATA

(71) Applicant: Adobe Inc., San Jose, CA (US)

(72) Inventors: Sanyam Jain, Delhi (IN); Nafisa Ahmed, Bengaluru (IN); Pallavi Sharma, Yamunanagar (IN); Pranay Kumar Reddy L, Bengaluru (IN); Ravi Kiran P, Delhi (IN); Veena Datta Dasika, Andhra Pradesh (IN); Vennela Kailasa, Bengaluru (IN)

(21) Appl. No.: 19/183,236

(22) Filed: Apr. 18, 2025

(51) Int. Cl. G06T 11/60; G06F 9/50; G06F 16/93; G06F 40/109; G06T 11/10

(52) U.S. Cl. CPC G06T 11/60; G06F 9/5027; G06F 16/93; G06F 40/109; G06T 11/10; G06T 2200/24

(57) ABSTRACT

A digital document editing computing system converts a first document file lacking hierarchical data to a second document file including hierarchical data. Using element tags for the first digital document, the digital document editing computing system generates a shared mapping data object including nodes which indicate document structure data extracted from digital pages of the first digital document and memory location data for the extracted document structure data. Subsets of the nodes are allocated to memory threads of the digital document editing computing system. For each node subset, a memory thread generates editable data elements including document content data from the digital page and hierarchy data. The memory thread generates the second digital document file including the editable data elements. The digital document editing computing system provides the second digital document file to a computing system configured to display the editable data elements based on the hierarchy data.

### TECHNICAL FIELD

This disclosure relates generally to the field of digital document conversion, and more specifically relates to automated techniques to convert digital file types.

### BACKGROUND

Document design specialists often digitally convert document information among multiple digital file types. A document design specialist, such as a graphic designer, may have a need to convert digital document information among digital file types that are optimized for a variety of uses by a computing system, such as files that are optimized for digital editing within a computer application, files that are optimized for physical fidelity (e.g., printable documents), files that are optimized for digital fidelity (e.g., websites), or additional digital file types for additional uses by a computing system.

In some cases, converting digital document information accurately and quickly among digital file types is of high importance to a user such as a document design specialist. For example, a document design specialist may have a task-related need to convert a digital document from a first file type to a second type. Examples of task-related needs can include user situations such as using a document with a particular file type that includes non-editable data to create a document with another file type with data that is more easily edited, or other situations in which a user requires fast and accurate tools to convert digital document information.

Contemporary tools for converting digital document information may be insufficient for the needs of some document design specialists. For example, some computer-implemented editing tools, such as document design environments, may lack functions to convert a first document file type with non-hierarchical or non-editable data to a second document file type with hierarchical or editable data. In some cases, a document design specialist may utilize multiple contemporary computer-implemented editing tools to perform different aspects of a task-related need, such as using a first tool to display a document with non-editable data, a second tool to extract the non-editable data from the document, and a third tool to edit the extracted data. The use of multiple contemporary editing tools to perform different aspects can be disruptive for the document design specialist, reducing efficiency and distracting the person from the creative process of editing. In addition, the multiple contemporary editing tools may have poor intercommunication, resulting in loss of document information as the different techniques are performed by various tools.

It is desirable to develop a computer-implemented document design environment that can convert digital document information among digital file types quickly and accurately, including non-editable data to editable data. It is also desirable that the computer-implemented document design environment can convert digital document information among digital file types without interruption for a user, such as a document design specialist.

### SUMMARY

According to certain embodiments, a digital document editing computing system generates a digital document having a particular file type that includes hierarchical data from an additional digital document having an additional file type that lacks hierarchical data. Based on a set of element tags that are received with a first digital document file, the digital document editing computing system generates a shared mapping data object that includes multiple nodes. Each node includes at least one of document structure data or memory location data. The document structure data is extracted from non-editable data elements in the first digital document file. The memory location data indicates a memory location of the extracted document structure data.

In some implementations, the digital document editing computing system includes a memory component with multiple memory threads. Subsets of nodes in the shared mapping data object are allocated to the memory threads, such as subsets of nodes associated with digital pages or other portions of the first digital document file. Based on an allocated subset of nodes, a memory thread identifies document content data associated with the document structure data for the subset of nodes. The memory thread generates editable data elements that include the identified document content data and hierarchy data which indicates hierarchical relationships among the editable data elements. The memory thread generates a second digital document file that includes the editable data elements. The digital document editing computing system provides the second digital document file to an additional computing system that is configured to display the editable data elements in a visual arrangement that is based on the hierarchical relationships.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings, where:

FIG. 1 is a diagram depicting an example of a computing environment in which a digital document editing computing system is configured to generate digital documents that have a hierarchical file type, according to certain embodiments;

FIG. 2 is a diagram depicting an example of a digital document editing computing system that includes a memory component configured for memory parallelization techniques for generating a hierarchical document file, according to certain embodiments;

FIG. 3 is a diagram depicting examples of data structures generated or modified by a digital document editing computing system, according to certain embodiments;

FIG. 4 is a flow chart depicting an example of a process for generating a document that has a hierarchical file type, according to certain embodiments;

FIG. 5 is a flow chart depicting an example of a process for additional data processing of text data, font data, or list text data which can be performed during generation of a document that has a hierarchical file type, according to certain embodiments;

FIG. 6 is a flow chart depicting an example of a process for additional data processing of image data which can be performed during generation of a document that has a hierarchical file type, according to certain embodiments;

FIG. 7 is a flow chart depicting an example of a process for additional data processing of vector path data which can be performed during generation of a document that has a hierarchical file type, according to certain embodiments;

FIG. 8 is a flow chart depicting an example of a process for additional data processing of color data which can be performed during generation of a document that has a hierarchical file type, according to certain embodiments; and

FIG. 9 is a block diagram depicting an example of a computing system for implementing a digital document editing computing system, according to certain embodiments.

### DETAILED DESCRIPTION

As discussed above, prior techniques for converting digital documents or digital document information include utilizing multiple contemporary computer-implemented editing tools to perform different aspects of conversion (e.g., manual conversion of digital documents). In some cases, the multiple contemporary computer-implemented editing tools may lack intercommunication among the various contemporary tools, and can cause loss of document information as a digital document, or interim data for a particular conversion step, is transferred among the various contemporary tools. Additionally or alternatively, utilizing the multiple contemporary computer-implemented editing tools can interrupt a workflow for a person, such as a document design specialist, who desires to complete the conversion as a portion of a user-driven task. As an example, a document design specialist may be converting digital documents or digital document information as a precursor task before utilizing the converted information in another task, such as a task-related need to edit or generate additional document information. In this example, the document design specialist can become frustrated by time delays, workflow interruptions, loss of digital information, or other negative outcomes caused by switching among the multiple contemporary computer-implemented editing tools while performing the different aspects of conversion.

In some cases, contemporary tools for converting digital documents or digital document information lack functionality to convert the digital documents or digital document information from a first file type to a second file type, such as from a first file type that includes non-editable data that lacks hierarchy information to a second file type that includes editable data that includes hierarchy information. In some cases, the lack of functionality to convert non-editable data to editable data can be frustrating for users, such as document design specialists, who desire to modify or otherwise perform tasks with editable information. Additionally or alternatively, the lack of functionality to convert data lacking hierarchy information to data including hierarchy information can also be frustrating for users who desire to efficiently perform tasks for manipulating data that is displayed a digital document page. As an example of a task for using hierarchy information to efficiently manipulate data, a document design specialist may desire to use a hierarchical relationship between a clipping path data element and an image data element to mask a portion of the image data element, such as by modifying the hierarchical relationship to indicate that the clipping path data element is visually above (e.g., assigned to a layer that appears to be closer to a viewer) the image data element. In this example, a lack of hierarchy information could complicate the task, and the document design specialist may be frustrated by having to use additional, more inefficient techniques to mask the portion of the image data element.

Certain embodiments described herein provide for digital information conversion techniques for generating one or more digital documents that include editable and hierarchical data. In some cases, the digital information conversion techniques include using a first digital document having a first file type that includes non-editable data and lacks hierarchy information to generate at least one second digital document having a second file type that includes editable data and includes hierarchy information. A digital document editing computing system that is configured to implement the described techniques can utilize memory parallelization techniques to more efficiently generate the one or more digital documents including the editable and hierarchical data. Additionally or alternatively, the example digital document editing computing system configured to implement the described techniques can improve a workflow for a user of the digital document editing computing system, such as a document design specialist, such as by reducing interruptions or loss of information related to manual conversion of digital documents.

The following examples are provided to introduce certain embodiments of the present disclosure. A digital document editing computing system receives a first digital document file and a set of element tags associated with the first digital document file. In this example, the first digital document file has a first file type that lacks hierarchy information (such as a .PDF file type). The set of element tags describe non-editable data elements included in the first digital document file, such as non-editable data elements that depict text, images, colors, vector path graphics (or other vector path data), or other types of non-editable data that can be depicted in a digital document. As used herein, “non-editable” refers to a data element that cannot be edited via a document design environment. An example of a non-editable data element is a data element that is depicted on a digital page of a document file having a .PDF file type, e.g., the document file having the .PDF file type does not enable modifications to text, images, or other data elements depicted in the document file. Based on the set of element tags, the digital document editing computing system generates a shared mapping data object. The shared mapping data object describes at least one data structure that includes nodes, such as a tree graph data structure in which the nodes are arranged. In addition, the shared mapping data object describes at least one data structure that includes memory location data, such as a table (or other data structure) in which memory register addresses (or other types of memory locations) are stored. In this example, one or more nodes in the shared mapping data object includes at least one of document structure data or memory location data. The digital document editing computing system extracts the document structure data from the set of element tags. Additionally or alternatively, the digital document editing computing system assigns particular memory location data to each node in the shared mapping data object.

Continuing with this example, the digital document editing computing system allocates subsets of the nodes to a group of memory threads that are included in the digital document editing computing system, such as subsets of nodes that are respectively related to digital pages of the first digital document file. Each particular memory thread in the group identifies, based on the respective subsets of nodes allocated to the particular thread, document content data that is associated with the document structure data included in the allocated subset of nodes. The document content data is included in a particular page of the first digital document file that is associated with the allocated subset of nodes. The particular memory thread generates editable data elements for one or more nodes in the allocated subset of nodes. For a first node in the allocated subset of nodes, the particular memory thread generates a first editable data element that includes first document content data associated with first document structure data of the first node. In addition, the first editable data element includes hierarchy data that indicates one or more hierarchical relationships of the first editable data element. For example, the hierarchy data indicates a particular hierarchical relationship of the first editable data element with a second editable data element. In this example, the particular memory thread generates the second editable data element for a second node in the allocated subset of nodes. Additionally or alternatively, the particular memory thread generates a second digital document file that includes the first editable data element and the second editable data element having the particular hierarchical relationship. In this example, the second digital document file has a second file type that includes hierarchy information (such as a .INDD file type), such as a hierarchical document file.

The digital document editing computing system provides the second digital document file to an additional computing system that is configured to display the second digital document file, such as display via a document design environment implemented on the additional computing system. In some cases, the digital document editing computing system generates a combined digital document file, such as a combined hierarchical document file, that includes the second digital document file combined with one or more additional digital document files that include hierarchy information. For example, if each memory thread in the group of threads generates at least one hierarchical document file based on the respective subsets of nodes allocated to the memory threads, the digital document editing computing system generates the combined hierarchical document file based on the at least one hierarchical document file from each of the memory threads. Based on the second digital document file or combined hierarchical document file including the second digital document file, the additional computing system displays editable data element from the document file in a visual arrangement that is based on the hierarchy information included in the document file. In some cases, the document design environment implemented on the additional computing system displays a visual arrangement of the first editable data element and the second editable data element that is determined, by the document design environment, based on the particular hierarchical relationship between the first editable data element and the second editable data element.

Certain embodiments described herein provide improvements to document conversion techniques and computing systems that implement document design environments. For example, a digital document editing computing system configured to implement one or more of the techniques described herein generates digital document files, such as hierarchical document files, based on one or more specialized data structures, such as a shared mapping data object that includes or represents a graph data structure. In addition, the digital document editing computing system generates the digital document files by applying particular rules that identify relationships among data associated with an input document file, such as relationships among document content data and document structure data. In some cases, the application of these rules by the digital document editing computing system achieves one or more improved technological results, such as improved accuracy of hierarchical information included in the generated digital document files. Additionally or alternatively, the digital document editing computing system is configured to generate the digital document files based on memory parallelization techniques as described herein. Based on the memory parallelization techniques, the digital document editing computing system improves efficient use of computing resources, such as by utilizing the shared mapping data object to reduce memory usage and increasing memory access speed related to storing image data or other types of data during document generation. In some cases, the digital document editing computing system improves an experience of humans who interact with a document design environment, such as by quickly providing a digital document file that includes accurate and complete document data, including editable data and hierarchical data. Additionally or alternatively, the digital document editing computing system improves an experience of humans who interact with the document design environment by eliminating inefficient workflows related to manual conversion of a digital document file, such as manual conversion that might have been performed using contemporary computer-implemented editing tools.

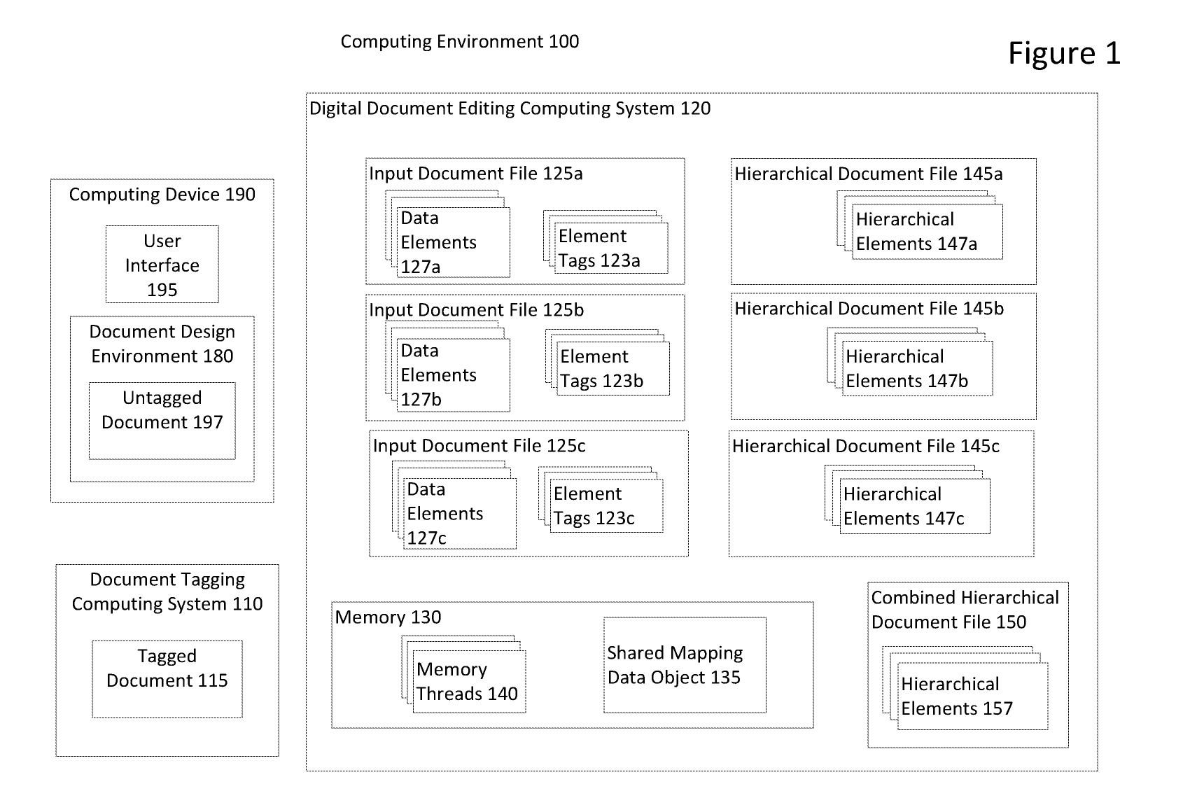

Referring now to the drawings, FIG. 1 is a diagram depicting an example of a computing environment 100 in which a digital document editing computing system 120 is configured to generate one or more documents that have a hierarchical file type, such as (at least) a combined hierarchical document file 150. The computing environment 100 includes the digital document editing computing system 120, a document tagging computing system 110, and one or more additional computing systems, such as a computing device 190 which includes a user interface 195. In some cases, one or more of the digital document editing computing system 120, the document tagging computing system 110, the computing device 190, or an additional computing system in the computing environment 100 are configured to exchange data via one or more computing networks, such as a local or global area network.

In some cases, the computing device 190 is configured to implement a document design environment 180, such as a computer-implemented document design environment in which a user (e.g., a document design specialist) modifies digital documents. For example, the computing device 190 provides, via the user interface 195, at least one digital document and one or more editing functions available in the document design environment 180. Additionally or alternatively, one or more of the editing functions available in the document design environment 180 are provided via the digital document editing computing system 120, the document tagging computing system 110, or an additional computing system. For example, the computing device 190 could provide an editing function based on data exchanged with one or more of the digital document editing computing system 120 or the document tagging computing system 110. An example of a document design environment in which digital documents can be modified include the InDesign software application from Adobe Inc.™, QuarkXpress from Quark Software Inc.™, or Affinity Publisher software application from Serif™, but other examples of document design environments are available.

In FIG. 1, the digital document editing computing system 120 generates one or more digital documents that include hierarchy information, such as hierarchy information that indicates relationships among multiple elements of a particular digital document. In some cases, the digital documents that include hierarchy information (also referred to herein as “hierarchical digital documents”) are generated by the digital document editing computing system 120 based on one or more input digital documents, such as input digital documents which lack hierarchy information or which have incomplete hierarchy information. Additionally or alternatively, the digital document editing computing system 120 generates one or more hierarchical digital documents in response to (or otherwise based on) one or more editing functions initiated within the document design environment 180, such as a document conversion editing function. In some cases, the one or more editing functions are related to a user task that is performed in the document design environment 180, such as a user task that includes converting at least one digital document having a first file type to one or more additional digital documents having a second file type. For example, the document design environment 180 receives one or more user inputs (e.g., via the user interface 195) indicating an untagged document 197 and at least one editing function related to the untagged document 197. In addition, the user input indicates that the editing function includes conversion of the untagged document 197 from a first file type to a second file type. For example, the untagged document 197 is of a first file type that lacks hierarchy information. An example of a file type that lacks hierarchy information or which has incomplete hierarchy information is a portable document format file type (e.g., .PDF), but other file types that lack or have incomplete hierarchy information are available. Additionally or alternatively, the editing function includes conversion of the untagged document 197 from the first file type to a second file type that includes hierarchy information, such as hierarchical digital documents generated by the digital document editing computing system 120. Examples of file types that include hierarchy information are an InDesign document file type (e.g., .INDD) or an Affinity Publisher document file type (e.g., .AFPUB), but other file types that include hierarchy information are available.

In some cases, a user of the computing device 190 provides the user input indicating the document conversion editing function as part of a user-driven task within the document design environment 180, such as a user-driven task to convert the untagged document 197 to a hierarchical digital document. In addition, the user-driven task is of high importance to the user while performing activities within the document design environment 180. For example, the user may be instructed to use the untagged document 197 as part of a job-related task or other types of tasks, such as a job-related task to revise information (e.g., text, images) that are depicted in the untagged document 197. In FIG. 1, information depicted in the untagged document 197 is non-editable, e.g., data elements such as text or images in the untagged document 197 cannot be modified via the document design environment 180. In addition, the job-related task of the user requires revision of some or all of the data elements in the untagged document 197. In this example, the user of the document design environment 180 utilizes the editing function, e.g., converting the untagged document 197 to a hierarchical digital document, as a high-importance activity that is part of the job-related task (or other user-driven task) requiring revision of information e.g., data elements, included in the untagged document 197. In some cases, the digital document editing computing system 120 generates a hierarchical digital document based on the untagged document 197 more accurately and more quickly than contemporary techniques for document conversion (e.g., manual conversion utilizing multiple tools).

In FIG. 1, the document tagging computing system 110 receives the untagged document 197 from the computing device 190, such as in response to the user input indicating the document conversion editing function. In addition, the document tagging computing system 110 generates a tagged document 115 based on the untagged document 197. For example, the document tagging computing system 110 identifies, in the untagged document 197, one or more data elements that include information depicted in the untagged document 197. Examples of data elements can include text paragraphs (or other text groupings), images, colors, or other types of data elements. In FIG. 1, the data elements identified by the document tagging computing system 110 are content data in the first file type (e.g., a .PDF file type) for the untagged document 197. In addition, the data elements identified by the document tagging computing system 110 are non-editable, such as non-editable portions of the untagged document 197 (e.g., non-editable text depicted on .PDF pages). Additionally or alternatively, the document tagging computing system 110 generates tag data that describes the identified data elements. In FIG. 1, the tag data generated by the document tagging computing system 110 is structure data that is determined from the untagged document 197. Examples of tag data can include paragraph tags, indentation tags, alignment tags, spacing tags, or other types of tag data indicating structure in a file type that includes data elements, such as structure determined from the first file type for the untagged document 197. In some cases, the tagged document 115 generated by the document tagging computing system 110 is of the first file type that lacks hierarchy information, such as the same (or similar) first file type of the untagged document 197, e.g., a .PDF file type. Additionally or alternatively, the tagged document 115 includes the data elements identified by and the tag data generated by the document tagging computing system 110. In FIG. 1, the data elements and the tag data included in the tagged document 115 do not indicate a hierarchy among the data elements or tag data, and the tagged document 115 lacks (or has incomplete) hierarchy data.

In some cases, the document tagging computing system 110 includes one or more machine-learning models that are configured to identify the one or more data elements in the untagged document 197. Additionally or alternatively, the document tagging computing system 110 includes one or more machine-learning models that are configured to generate the tag data that describes the data elements identified in the untagged document 197. Examples of machine-learning models that can be configured to identify data elements or generate tag data can include large language models or vision language models, but other techniques are possible. FIG. 1 depicts the digital document editing computing system 120 and the document tagging computing system 110 as individual computing systems, but other implementations are possible. For example, a digital document editing computing system could include one or more machine-learning models configured to generate tagging information for digital documents. As an additional example, a particular computing system could implement both a digital document editing sub-system and a document tagging sub-system (e.g., sub-systems implemented via software applications running on the particular computing system).

In the computing environment 100, the digital document editing computing system 120 generates at least one hierarchical digital document based on one or more of the tagged document 115 or the untagged document 197. For example, the digital document editing computing system 120 receives the tagged document 115 as an input, such as an input from the document tagging computing system 110. Additionally or alternatively, the digital document editing computing system 120 determines one or more portions of the tagged document 115 that include at least one data element and at least one element tag associated with the at least one data element. Examples of the portions of the tagged document 115 can be digital pages, such as digital pages having the first file type, but other types of document portions are available. In FIG. 1, the digital document editing computing system 120 extracts or otherwise determines one or more document files from the tagged document 115. Additionally or alternatively, the digital document editing computing system 120 receives (or otherwise accesses) the extracted document files as inputs. For example, the digital document editing computing system 120 extracts from the tagged document 115 one or more of an input document file 125a, an input document file 125b, or an input document file 125c (referred to collectively herein as input document files 125). In addition, the digital document editing computing system 120 determines that each extracted document portion includes (or is otherwise associated with) at least one data element and associated tag data that describes the at least one data element. For example, the digital document editing computing system 120 determines that the input document file 125a includes one or more data elements 127a and element tags 123a that describe the data elements 127a, the input document file 125b includes one or more data elements 127b and element tags 123b that describe the data elements 127b, and the input document file 125c includes one or more data elements 127c and element tags 123c that describe the data elements 127c. The data elements 127a, 127b, and 127c are referred to collectively herein as data elements 127. The element tags 123a, 123b, and 123c are referred to collectively herein as element tags 123.

In some cases, the digital document editing computing system 120 receives the untagged document 197 from one or more of the computing device 190 or the document tagging computing system 110. Additionally or alternatively, the digital document editing computing system 120 can associate portions of the tagged document 115 with respective portions of the untagged document 197, e.g., associating tagged pages with untagged pages. For example, the digital document editing computing system 120 can associate one or more of the input document file 125a, the data elements 127a, or the element tags 123a with a first untagged page of the untagged document 197; one or more of the input document file 125b, the data elements 127b, or the element tags 123b with a second untagged page of the untagged document 197; or one or more of the input document file 125c, the data elements 127c, or the element tags 123c with a third untagged page of the untagged document 197.

In the computing environment 100, the digital document editing computing system 120 generates the at least one hierarchical digital document based on the determined document portions, such as the input document files 125 extracted from the tagged document 115. For example, the digital document editing computing system 120 generates a hierarchical document file 145a based on one or more of the input document file 125a, the data elements 127a, or the element tags 123a; a hierarchical document file 145b based on one or more of the input document file 125b, the data elements 127b, or the element tags 123b; and a hierarchical document file 145c based on one or more of the input document file 125c, the data elements 127c, or the element tags 123c. Additionally or alternatively, the digital document editing computing system 120 generates one or more hierarchical elements 147a that are included in the hierarchical document file 145a, one or more hierarchical elements 147b that are included in the hierarchical document file 145b, and one or more hierarchical elements 147c that are included in the hierarchical document file 145c. The hierarchical document files 145a, 145b, and 145c are referred to collectively herein as hierarchical document files 145. The hierarchical elements 147a, 147b, and 147c are referred to collectively herein as hierarchical elements 147.

In FIG. 1, the digital document editing computing system 120 generates the hierarchical document files 145 and the hierarchical elements 147 based on combinations of the input document files 125, the data elements 127, and the element tags 123. Additionally or alternatively, each of the hierarchical document files 145 and the included hierarchical elements 147 are respectively generated by particular memory threads of the digital document editing computing system 120. For example, the digital document editing computing system 120 includes a memory 130, such as a memory component (or components) included in or otherwise accessible by the computing system 120. Additionally or alternatively, the digital document editing computing system 120 allocates a first portion of the memory 130 as a group of multiple memory threads 140 and a second portion of the memory 130 as a shared mapping data object 135. In some cases, each thread in the group of memory threads 140 can operate autonomously or semi-autonomously, such as performing at least some operations without input from additional threads in the group of memory threads 140. In some cases, the shared mapping data object 135 is a data structure that is accessible by each thread in the group of memory threads 140. In some implementations, the shared mapping data object 135 is stored in a shared portion of the memory 130, such as a shared cache that is accessible by each of the memory threads 140.

In the computing environment 100, the digital document editing computing system 120 generates the shared mapping data object 135 based on one or more of the input document files 125, the data elements 127, or the element tags 123. Based on analysis of the data elements 127 and the element tags 123, digital document editing computing system 120 generates (or modifies) the shared mapping data object 135, such as by generating (or modifying) nodes that are included in a graph data structure, such as an n-child tree graph data structure, that is represented by the shared mapping data object 135. For example, for each data element in the data elements 127 and for each tag in the element tags 123, the digital document editing computing system 120 generates a respective node in the graph data structure represented by the shared mapping data object 135. Additionally or alternatively, the digital document editing computing system 120 determines an arrangement of the nodes in the graph data structure based on the element tags 123, such as modifying a tree arrangement of the nodes based on a relationship among the element tags 123. In FIG. 1, each node in the graph data structure represented by the shared mapping data object 135 includes document structure data, e.g., based on at least one tag from the element tags 123, and memory location data, e.g., indicating a location within the memory 130.

In some implementations, the digital document editing computing system 120 modifies the graph data structure represented by the shared mapping data object 135 to include particular graph portions that are respectively associated with particular input document files in the input document files 125. For example, the digital document editing computing system 120 modifies the shared mapping data object 135 to include (or otherwise represent) a first graph portion, e.g., a first sub-tree of the graph data structure, that is associated with the input document file 125a. In this example, each node of the first sub-tree represents a particular data element from the data elements 127a and the arrangement of the nodes in the first sub-tree represents hierarchical relationships that are indicated by the element tags 123a, e.g., a particular graph path between two of the nodes indicates a particular hierarchical relationship between the data elements represented by the two nodes. Additionally or alternatively, the digital document editing computing system 120 modifies the shared mapping data object 135 to include (or otherwise represent) a second graph portion, e.g., a second sub-tree of the graph data structure, that is associated with the input document file 125b. In this example, each node of the second sub-tree represents a particular data element from the data elements 127b and the arrangement of the nodes in the second sub-tree represents hierarchical relationships that are indicated by the element tags 123b. Additionally or alternatively, the digital document editing computing system 120 modifies the shared mapping data object 135 to include (or otherwise represent) a third graph portion, e.g., a third sub-tree of the graph data structure, that is associated with the input document file 125c. In this example, each node of the third sub-tree represents a particular data element from the data elements 127c and the arrangement of the nodes in the third sub-tree represents hierarchical relationships that are indicated by the element tags 123c.

In FIG. 1, the memory threads 140 generate the hierarchical document files 145 based on the shared mapping data object 135, such as by identifying hierarchical relationships indicated by the graph data structure included in the shared mapping data object 135. For example, a first thread of the memory threads 140 generates the hierarchical document file 145a and the hierarchical elements 147a based on the input document file 125a and a first combination of the data elements 127a with the element tags 123a. In this example, the first memory thread determines the first combination based on the first graph portion of the shared mapping data object 135, such as the first sub-tree of the graph data structure. Additionally or alternatively, a second thread of the memory threads 140 generates the hierarchical document file 145b and the hierarchical elements 147b based on the input document file 125b and a second combination of the data elements 127b with the element tags 123b. In this example, the second memory thread determines the second combination based on the second graph portion of the shared mapping data object 135, such as the second sub-tree of the graph data structure. Additionally or alternatively, a third thread of the memory threads 140 generates the hierarchical document file 145c and the hierarchical elements 147c based on the input document file 125c and a third combination of the data elements 127c with the element tags 123c. In this example, the third memory thread determines the third combination based on the third graph portion of the shared mapping data object 135, such as the third sub-tree of the graph data structure.

In some implementations, each of the first thread, second thread, and third thread accesses the shared mapping data object 135 during respective operations for generating the hierarchical document files 145 and the hierarchical elements 147. For example, the first thread may determine that a particular one of the data elements 127a includes an image. The first thread may access the shared mapping data object 135 to indicate (e.g., by setting a flag) that the image is being processed by the first thread. In addition, the second thread may determine that a particular one of the data elements 127b includes an image, and also determine that the image in the particular one of the data elements 127b is a same image as in the particular one of the data elements 127a. The second thread may access the shared mapping data object 135 to determine if the image is being processed. Based on the indication from the first thread (e.g., the set flag), the second thread may determine that the image is being processed. Responsive to determining that the image is being processed by another thread, the second thread may pause processing of the image until receiving alert data (e.g., a modification of the set flag) indicating that processing of the image is completed. In some cases, the digital document editing computing system 120 may store the processed image in the shared mapping data object 135, such that the first and second threads (and any additional threads that determine particular ones of the data elements 127 which include the image) can access the processed image.

In some cases, storage of (or otherwise providing access to) one or more processed images or other processed data elements can improve efficiency for the memory threads 140. For example, the input document files 125 could include multiple instances of various data elements, such as images, color palettes, fonts, text blocks, or other types of data elements that might be present in multiple files of the input document files 125. As an example, each of the input document files 125 could include a page header including an image and a text block (e.g., an organization logo and an address), such that all of the input document files 125 have at least the same image and same text block in the page header. Based on a determination that the shared mapping data object 135 includes or provides access to a data element that has been processed by a particular thread from the memory threads 140, one or more additional threads of the memory threads 140 may eliminate redundant operations, such as by utilizing the processed data elements from the shared mapping data object 135 (e.g., instead of performing additional operations to process the data element again). In the above example of the page header included in the input document files 125, for instance, the first thread and second thread from memory threads 140 could eliminate operations responsive to determining, using the shared mapping data object 135, that the third memory thread has processed the data elements of the page header and stored the processed data elements via the shared mapping data object 135.

In some implementations, the digital document editing computing system 120 allocates particular document portions, such as document portions extracted from the tagged document 115, to particular threads of the group of memory threads 140. In some cases, allocating particular document portions to particular memory threads can improve processing efficiency for generating the hierarchical document files 145 or the combined hierarchical document file 150. For example, the memory threads 140 included in the memory 130 are configured to implement parallel processing, e.g., each thread in the group of memory threads 140 is capable of performing at least some operations in parallel with additional threads in the group of memory threads 140. In addition, allocating particular document portions to particular memory threads can decrease wait time for a user who is awaiting an output from the digital document editing computing system 120, such as the hierarchical document files 145 or the combined hierarchical document file 150. For instance, continuing with the above example, the input document file 125a is allocated to the first memory thread, the input document file 125b is allocated to the second memory thread, and the input document file 125c is allocated to the third memory thread. In this example, the digital document editing computing system 120 allocates an additional portion from the tagged document 115, e.g., an additional input document file in the input document files 125, to a particular thread.

In some cases, the digital document editing computing system 120 allocates document portions to memory threads based on one or more of a quantity of available memory threads or a quantity of document portions to be allocated. Additionally or alternatively, the digital document editing computing system 120 can utilize one or more techniques for scheduling processing of different document portions, such techniques to schedule processing of pages in a multi-page PDF file. In some cases, such as in response to determining an availability of idle threads in the group of memory threads 140, the digital document editing computing system 120 selects a technique for scheduling processing of document portions that can optimize memory usage and efficiently utilize multiple threads. As an example, if the digital document editing computing system 120 determines that the quantity of document portions can be allocated equally among the quantity of memory threads, then the digital document editing computing system 120 can allocate an equal quantity of document portions to each memory thread. Examples of equivalent allocation of document portions can include allocating a particular quantity of input document files per memory thread (e.g., two pages per thread), a particular quantity of input document file data per memory thread (e.g., pages including about 100MB per thread), or other techniques for equivalent allocation of document portions across the group of memory threads 140. In this example, equivalent allocation of document portions across memory threads can improve processing efficiency, such as by using parallel memory operations to efficiently process the document portions.

As an additional example, if the digital document editing computing system 120 determines that the quantity of document portions cannot be allocated equally among the quantity of memory threads, then the digital document editing computing system 120 can allocate one or more additional document portions to at least one particular memory thread, such as an overload thread. Examples of overloaded allocation of document portions can include allocating a relatively large quantity of input document files (or input document file data) to a relatively large quantity of memory threads (e.g., a majority of input document files allocated to 85% of available memory threads) and a remaining quantity of input document files (or input document file data) to a remaining quantity of memory threads (e.g., a minority of input document files allocated to 15% of available memory threads identified as overload threads), or other techniques for overloaded allocation of document portions across the group of memory threads 140. In this example, overloaded allocation of document portions across memory threads can improve wait time for a user who is awaiting an output from the digital document editing computing system 120, such as by using a relatively large number of memory threads to quickly output a majority of hierarchical document files and a relatively small number of overload threads to more slowly output a minority of the hierarchical document files. In some cases, the digital document editing computing system 120 identifies a particular thread from the group 140 as a main thread. Additionally or alternatively, during an overloaded allocation technique the main thread can coordinate processing of document portions that are allocated to the relatively large quantity of memory threads, such as coordinating an order of pages that are processed by additional memory threads. In some cases, the main thread can be allocated at least part of the remaining quantity of input document files (or input document file data), such as a small number of pages that are not allocated to the relatively large quantity of memory threads.

In the computing environment 100, the digital document editing computing system 120 generates, based on a combination of two or more of the hierarchical document files 145 or the hierarchical elements 147, the combined hierarchical document file 150 and one or more hierarchical elements 157 included in the combined hierarchical document file 150. In some cases, the combined hierarchical document file 150 can include a particular arrangement of the hierarchical document files 145, such as an arrangement of digital pages. For example, the combined hierarchical document file 150 can include digital pages, e.g., the hierarchical document files 145 or copies thereof, in an ordered arrangement that matches (or is similar to) an ordered arrangement of digital pages in the untagged document 197 or the tagged document 115. Additionally or alternatively, the hierarchical elements 157 in the combined hierarchical document file 150 are in a particular arrangement that is based on the hierarchical elements 147. For example, the digital pages in the combined hierarchical document file 150 can include portions of the hierarchical elements 157 in an arrangement that matches (or is similar to) an arrangement of the hierarchical elements 147 in the respective hierarchical document files 145, e.g., a first portion of the hierarchical elements 157 has a first arrangement on a first digital page that matches an arrangement of the hierarchical elements 147a in the hierarchical document file 145a, a second portion of the hierarchical elements 157 has a second arrangement on a second digital page that matches an arrangement of the hierarchical elements 147b in the hierarchical document file 145b, and a third portion of the hierarchical elements 157 has a third arrangement on a third digital page that matches an arrangement of the hierarchical elements 147c in the hierarchical document file 145c.

In FIG. 1, one or more of the combined hierarchical document file 150 or the hierarchical document files 145 have a second file type, such as the second file type indicated by the editing function performed via the document design environment 180. In some cases, the second file type can be a file type that includes hierarchy information (e.g., an InDesign document file type). Additionally or alternatively, one or more of the combined hierarchical document file 150 or the hierarchical document files 145 include hierarchy information that fulfills a criteria of the editing function, such as a criteria of the document conversion editing function for converting the untagged document 197 to at least one digital document having hierarchy information, e.g., the combined hierarchical document file 150 or the hierarchical document files 145. In the combined hierarchical document file 150 or the hierarchical document files 145, the hierarchy information indicates hierarchical relationships among hierarchical data elements, such as the hierarchical elements 157 and the hierarchical elements 147. Examples of hierarchical relationships can include grouping relationships (e.g., data elements based on nodes included in a particular sub-tree of the graph data structure in the shared mapping data object 135), parent-child relationships (e.g., a first data element based on a parent node and a second data element based on a child node in the graph data structure in the shared mapping data object 135), sibling relationships (e.g., multiple data elements based on multiple nodes sharing a particular parent node in the graph data structure in the shared mapping data object 135), or other types of hierarchical relationships among data elements.

In FIG. 1, each of the hierarchical elements 147 and the hierarchical elements 157 include hierarchy information that indicates a hierarchical relationship with additional hierarchical elements. For example, each of the hierarchical elements 157 includes hierarchy information indicating one or more hierarchical relationships with at least one additional data element from the hierarchical elements 157, each of the hierarchical elements 147a includes hierarchy information indicating one or more hierarchical relationships with at least one additional data element from the hierarchical elements 147a, each of the hierarchical elements 147b includes hierarchy information indicating one or more hierarchical relationships with at least one additional data element from the hierarchical elements 147b, and each of the hierarchical elements 147c includes hierarchy information indicating one or more hierarchical relationships with at least one additional data element from the hierarchical elements 147c.

In FIG. 1, one or more of the hierarchical elements 147 or the hierarchical elements 157 are editable information, e.g., content data (such as text or images) in hierarchical data elements can be modified, such as via the document design environment 180. Additionally or alternatively, hierarchy information in the hierarchical elements 147 or the hierarchical elements 157 is editable information, e.g., structure data (such as hierarchical relationships among hierarchical data elements) can be modified, such as via the document design environment 180. Examples of hierarchy information that can be modified can include inclusion or exclusion of a data element in a relationship (e.g., a data element that is added or removed from a hierarchical relationship); modification of a parent, child, or sibling relationship among data elements; modification of metadata about a hierarchical relationship (e.g., modifying a grouping relationship to include a “Do Not Print” data flag to automatically exclude data elements in the grouping relationship from printing); or other types of modifications to hierarchy information.

In FIG. 1, the combined hierarchical document file 150 is provided to the computing device 190. Additionally or alternatively, the computing device 190 is configured to provide the combined hierarchical document file 150 to the user (e.g., the example document design specialist), such as via one or more display devices included in the user interface 195. In some cases, the computing device 190 displays one or more data elements in the combined hierarchical document file 150 based on hierarchical relationships among the data elements. For example, the computing device 190 displays a visual arrangement of the hierarchical elements 157 that is based on hierarchical relationships among the hierarchical elements 157.

An example of a visual arrangement can include an appearance of a particular data element in relationship with an appearance of an additional data element, such as an appearance in which the particular data element is at least partly obscured by the additional data element, e.g., text content that is at least partly obscured by image content. An additional example of a visual arrangement can include a functionality of a particular data element in relationship with a functionality of an additional data element, such as a functionality in which multiple data elements can be edited as a functional group, e.g., a modification to a particular data element in the functional group will be applied to all data elements in the functional group. Examples of functional group modifications can include modifications to text font, text size, image ratio, mask sizes, mask shapes, color palette selections, or other types of modifications that can be applied to groups of multiple data elements.

In some cases, the document design environment 180 utilizes layers to describe hierarchical relationships among data elements, such as a set of layers in which each hierarchical data element is associated with a particular layer. In the document design environment 180, the layers can indicate an appearance hierarchical relationship, such as a visual arrangement in which a data element on a top layer visually appears to be in front of additional data elements on additional layers, e.g., below the top layer. Additionally or alternatively, the layers in the document design environment 180 can indicate a functional hierarchical relationship, such as a visual arrangement in which a particular layer is indicated as non-printing, e.g., all data elements on the particular layer are automatically omitted from printing operations in the document design environment 180.

In the computing environment 100, a user of the document design environment 180 (e.g., the example document design specialist) can utilize the digital document editing computing system 120 to complete at least one user-driven task, such as converting the untagged document 197 to a hierarchical digital document, such as the combined hierarchical document file 150 having the second file type (e.g., .INDD file type). In addition, the user can utilize the combined hierarchical document file 150 that is received by the document design environment 180 to perform additional user-driven tasks, such as modifying content data or structure data in the hierarchical elements 157. For example, the user may complete additional job-related tasks based on the combined hierarchical document file 150, such as using additional editing functions of the document design environment 180 to modify text content, graphical content, or hierarchical information included in the hierarchical elements 157. In some cases, subsequent to generation of the combined hierarchical document file 150 by the digital document editing computing system 120, the availability of the combined hierarchical document file 150 within the document design environment 180 improves workflows for user-driven tasks, such as simplifying or reducing time related to performing editing functions in the document design environment 180. Additionally or alternatively, the user may use the combined hierarchical document file 150 (or a modified version thereof) for a user-driven task that includes digital printing, such as generating one or more additional files having the first file type (e.g., additional .PDF files). In this example, a digital print function of the document design environment 180 generates the additional files having the first file type without modification of the combined hierarchical document file 150 having the second file type. Continuing with this example, the user can improve completion of job-related tasks by utilizing the combined hierarchical document file 150, such as more quickly and efficiently editing data in the hierarchical elements 157.

In some implementations, a digital document editing computing system is configured to utilize multiple memory threads to generate one or more hierarchical document files or combined hierarchical document files. For example, the multiple memory threads can be used to generate or modify a shared mapping data object that includes a graph data structure indicating document structure data of at least one input document file. In some cases, the digital document editing computing system is configured to apply the multiple memory threads in parallel, such as by utilizing memory parallelization techniques. For example, each thread in the multiple memory threads can perform at least some operations without input from additional threads in the multiple memory threads. Additionally or alternatively, each thread in the multiple memory threads can coordinate operations with additional threads in the multiple memory threads, such as by coordinating access to at least some portions of the shared mapping data object. As an example, each thread in the multiple memory threads can coordinate read/write access to one or more portions of the shared mapping data object that are currently accessed by additional threads in the multiple memory threads, such as to prevent two or more threads from operating concurrently on a same portion of the shared mapping data object. As an additional example, each thread in the multiple memory threads can coordinate read/write access to one or more portions of the shared mapping data object that have previously been accessed by additional threads in the multiple memory threads, such as to efficiently utilize shared mapping data object portions that have completed data processing without duplication of data processing operations.

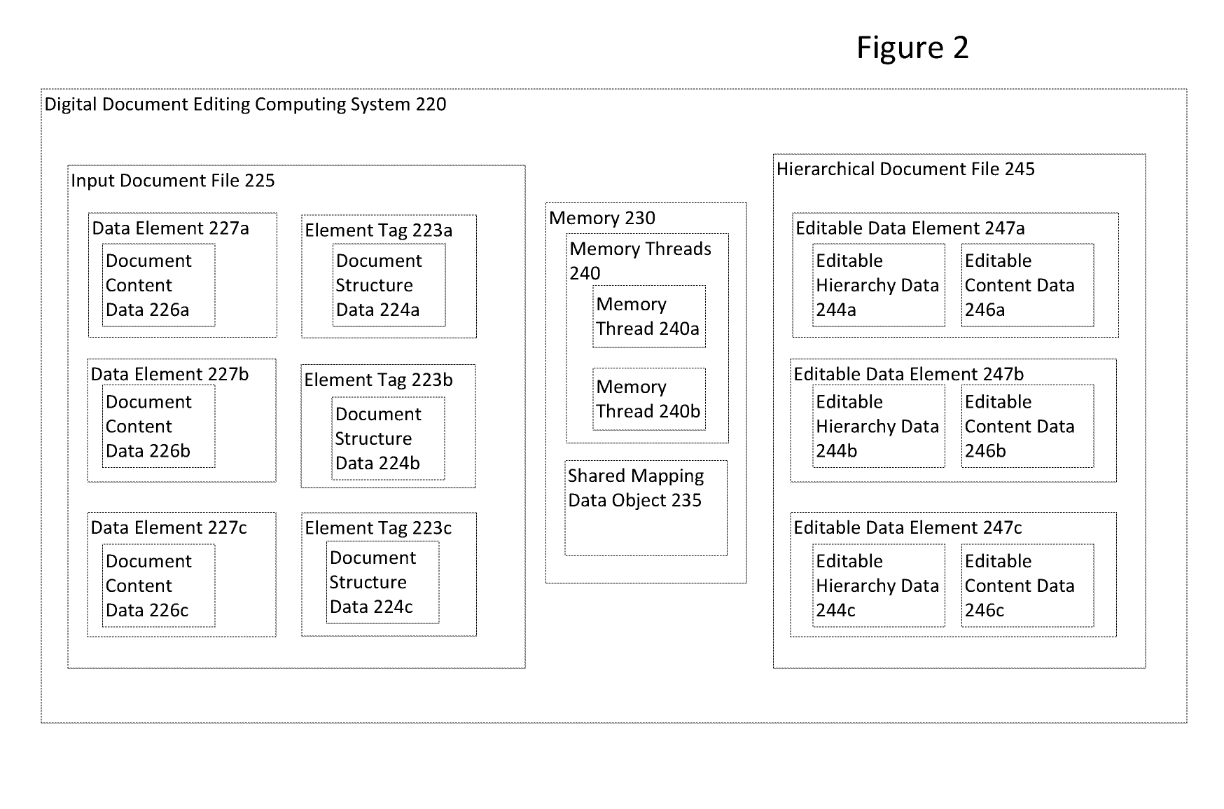

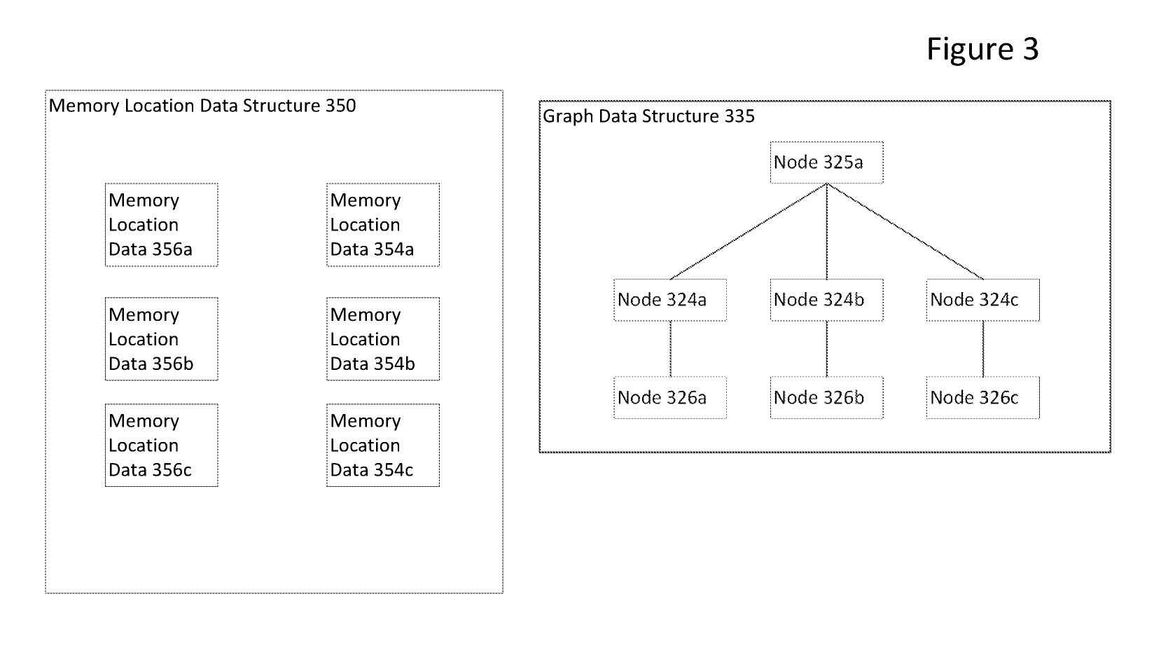

FIG. 2 depicts an example of a digital document editing computing system 220 that is configured to generate at least one hierarchical document file, such as a hierarchical document file 245. Additionally or alternatively, the digital document editing computing system 220 includes at least one memory component, such as a memory 230, that is configured for memory parallelization techniques for generating the at least one hierarchical document file. For example, the digital document editing computing system 220 executes one or more operations to allocate a first portion of the memory 230 as a group of memory threads 240 that include, at least, a memory thread 240a and a memory thread 240b. Additionally or alternatively, the digital document editing computing system 220 executes one or more operations to allocate a second portion of the memory 230 as a shared mapping data object 235. FIG. 3 includes diagrams depicting some examples of data structures generated or modified by the digital document editing computing system 220, such as a graph data structure represented by the shared mapping data object 235 or a data structure for storing memory location data for the memory 230. For convenience, FIG. 3 depicts the examples of data structures in a human readable format, but other implementations of data structures are possible, including data structures that are not intended for human interpretation.

In some implementations, the digital document editing computing system 220 is included in a computing environment, such as the computing environment 100 described in regard to FIG. 1. Additionally or alternatively, the digital document editing computing system 220 is configured to exchange data with at least one additional computing device, such as a document tagging computing system or a user computing device. For example, the digital document editing computing system 220 could receive at least one tagged document or untagged document, such as receiving the tagged document 115 from the document tagging computing system 110. In some cases, the digital document editing computing system 220 could provide the hierarchical document file 245 (or a combined hierarchical document file that is based on the hierarchical document file 245) to at least one additional computing device, such as to the document design environment 180 implemented on the computing device 190.

In FIG. 2, the digital document editing computing system 220 receives an input document file 225. For example, the digital document editing computing system 220 extracts the input document file 225 from a tagged file, such as the tagged document 115 described in regard to FIG. 1. In some cases, the digital document editing computing system 220 receives the tagged file from a document tagging computing system, such as the document tagging computing system 110. Additionally or alternatively, the digital document editing computing system 220 generates the tagged file, such as via one or more machine-learning models included in the digital document editing computing system 220. In FIG. 2, the input document file 225 lacks (or has incomplete) hierarchy data, and is extracted from a tagged file that also lacks (or has incomplete) hierarchy data. For example, the input document file 225 is extracted from a tagged file having a first file type that lacks hierarchy information, such as a .PDF file type. In some cases, the input document file 225 can be included in a group of multiple input document files extracted from the tagged file, such as a particular one of the input document files 125a, 125b, 125c, or an additional input document file included in the input document files 125.

In FIG. 2, the input document file 225 includes (or is associated with) at least one data element and at least one element tag. For example, the digital document editing computing system 220 determines that the input document file 225 includes multiple data elements, including a data element 227a, a data element 227b, and a data element 227c. Additionally or alternatively, the digital document editing computing system 220 determines that the input document file 225 includes (or is associated with) multiple element tags associated with respective data elements, such as an element tag 223a associated with the data element 227a, an element tag 223b associated with the data element 227b, and an element tag 223c associated with the data element 227c. The data elements 227a, 227b, and 227c are referred to collectively herein as data elements 227. The element tags 223a, 223b, and 223c are referred to collectively herein as element tags 223. In FIG. 2, the digital document editing computing system 220 determines that the data element 227a includes document content data 226a, the data element 227b includes document content data 226b, and the data element 227c includes document content data 226c. Additionally or alternatively, the digital document editing computing system 220 determines that the element tag 223a includes document structure data 224a, the element tag 223b includes document structure data 224b, and the element tag 223c includes document structure data 224c. The document structure data 224a, 224b, and 224c are referred to collectively herein as document structure data 224. The document content data 226a, 226b, and 226c are referred to collectively herein as document content data 226.

Examples of document structure data can include paragraph breaks, line breaks, indentation, list bullets, image alignment, vector paths, or other types of data describing structure of a digital document file. Examples of document structure data can include text, fonts, list bullet types (e.g., shapes), image scaling, image transparency, digital color space (e.g., RGB, CMYK), vector path fill, vector path color, or other types of data describing content of a digital document file.

In FIG. 2, the digital document editing computing system 220 generates or modifies the shared mapping data object 235 based on data included in the input document file 225, such as by executing one or more operations to cause modifications to the memory 230. For example, based on one or more operations executed by the digital document editing computing system 220, a particular thread included in the memory 230 (e.g., a main thread, a background thread) determines a graph data structure that is represented by the shared mapping data object 235, such as a tree graph data structure. In some cases, the digital document editing computing system 220 generates or modifies the shared mapping data object 235 to represent a graph data structure 335 depicted in FIG. 3. In FIG. 3, the graph data structure 335 is an n-child tree graph structure, such as a tree graph structure in which each branch node can have any quantity (e.g., quantity n) of child nodes.

In some cases, the memory 230 determines the graph data structure 335 based on one or more of the document structure data 224 or the document content data 226. Additionally or alternatively, the memory 230 assigns particular memory location data to each node included in the graph data structure 335. In FIG. 2, the memory 230 assigns the particular memory location data to a memory location data structure 350 depicted in FIG. 3. In some cases, the memory location data structure 350 is modified to indicate a particular location within the memory 230, such as a memory value map (also referred to herein as a MAP) indicating a particular memory value stored at a particular register within the memory 230. Additionally or alternatively, the memory location data structure 350 is modified to indicate a particular data value that is stored in the memory 230, such as a marked content identifiier (“MCID”) indicating a particular portion of document structure data or document content data identified from the input document file 225.

In the digital document editing computing system 220, the graph data structure 335 represented by the shared mapping data object 235 includes nodes arranged in a tree graph structure. In FIG. 3, the graph data structure 335 is depicted as including a node 325a, a node 324a, a node 324b, a node 324c, a node 326a, a node 326b, and a node 326c. In some cases, at least one of the nodes in the graph data structure 335 is associated with a particular portion of document structure data or document content data identified from the input document file 225. In some implementations, the graph data structure 335 includes one or more additional nodes, such as additional nodes associated with particular portions of document structure data or document content data identified from additional input document files received by the digital document editing computing system 220.

In the digital document editing computing system 220, each of the nodes in the graph data structure 335 is associated with at least one data value in the memory location data structure 350, such as memory location data assigned by the memory 230. In FIG. 3, the memory location data structure 350 is depicted as including memory location data 354a, memory location data 354b, memory location data 354c, memory location data 356a, memory location data 356b, and memory location data 356c. In FIG. 3, the memory location data 356a, the memory location data 356b, and the memory location data 356c are MCID data, which can be assigned to one or more of document structure data or document content data. Additionally or alternatively, the memory location data 354a, the memory location data 354b, and the memory location data 354c are MAP data, which can be assigned to document structure data.

In some cases, the memory 230 identifies, such as by parsing the data elements 227, each of the document content data 226a, the document content data 226b, and the document content data 226c. Based on the content parsing, the memory 230 associates a respective node and respective memory location data, such as MCID data, to each of the document content data 226a, the document content data 226b, and the document content data 226c. In FIG. 3, the document content data 226a is associated with the node 326a, which is assigned the memory location data 356a. In addition, the document content data 226b is associated with the node 326b, which is assigned memory location data 356b. In addition, the document content data 226c is associated with the node 326c, which is assigned memory location data 356c. In the graph data structure 335, each portion of document content data and the respective memory location data is represented as a leaf node in the tree graph structure. As used herein, “leaf node” is understood as a node in a tree graph structure that has a parent node and no child nodes, e.g., no additional nodes descending from a particular leaf node. In the graph data structure 335, the node 326a, the node 326b, and the node 326c are leaf nodes.

Additionally or alternatively, the memory 230 identifies, such as by parsing the element tags 223, each of the document structure data 224a, the document structure data 224b, and the document structure data 224c. Based on the structure parsing, the memory 230 assigns respective memory location data, such as MAP data, to each of the document structure data 224a, the document structure data 224b, and the document structure data 224c. In FIG. 3, the document structure data 224a is associated with the node 324a, which is assigned the memory location data 354a. In addition, the document structure data 224b is associated with the node 324b, which is assigned memory location data 354b. In addition, the document structure data 224c is associated with the node 324c, which is assigned memory location data 354c. In the graph data structure 335, each portion of document structure data and the respective memory location data is represented as a branch node in the tree graph structure. As used herein, “branch node” is understood as a node in a tree graph structure that has at least one child node, e.g., additional nodes may descend from a particular branch node.

In the graph data structure 335, the node 326a descends from (e.g., is a child node of) the node 324a, the node 326b descends from the node 324b, and the node 326c descends from the node 324c. In addition, each of the nodes 324a, 324b, and 324c descend from the node 325a. In some cases, the node 325a is a branch node that descends from an additional node in the graph data structure 335. For example, the node 325a could be associated with relatively low-level document structure data, such as an element tag that indicates a paragraph (e.g., <P> tag) that is one of multiple paragraphs in the input document file 225. In some cases, the node 325a is a root node, e.g., a particular branch node having no parent node and having at least one child node. For example, the node 325a could be associated with relatively high-level document structure data, such as an element tag that indicates a structure of the input document file 225 (e.g., <DOCUMENT> tag), from which other element tags in the input document file 225 descend.

In FIG. 2, the digital document editing computing system 220 generates or modifies the hierarchical document file 245 based on a combination of data included in the input document file 225, the graph data structure 335, and the memory location data structure 350. In some cases, the digital document editing computing system 220 generates or modifies the hierarchical document file 245 subsequent to generating or modifying the graph data structure 335 and the memory location data structure 350, e.g., subsequent to completing parsing of (at least) the document structure data 224. In FIG. 2, the digital document editing computing system 220 executes one or more operations which cause the memory threads 240 to perform parallel data processing of the input document file 225 and at least one additional input document file received by the digital document editing computing system 220. For example, based on one or more operations executed by the digital document editing computing system 220, the memory thread 240a begins data processing of the input document file 225. In some cases, the memory thread 240a processes the input document file 225 in parallel with additional processing performed by additional ones of the memory threads 240. For example, the memory thread 240a could processes the input document file 225 in parallel with the memory thread 240b performing data processing of an additional input document file.

In FIG. 2, the digital document editing computing system 220 allocates to the memory thread 240a the input document file 225 and an associated portion of the shared mapping data object 235, such as one or more associated portions of the memory location data structure 350 or the graph data structure 335. In addition, the memory thread 240a modifies the memory location data structure 350 based on the allocation of the input document file 225. For example, the memory thread 240a sets one or more indicators (e.g., data flags) in the memory 230 to show that data processing is being performed on nodes and/or memory location data associated with the input document file 225. In some cases, modifications made to the memory location data structure 350 by the memory thread 240a improve coordination with additional threads in the memory threads 240. For example, the digital document editing computing system 220 could allocate an additional input document file to the memory thread 240b, and the memory thread 240b could determine that additional document content data in the additional input document file is same or similar to a portion of document content data in the input document file 225. Examples of same or similar document content data in multiple input document files could be an image file, a color palette, a font, or other types of content data depicted on multiple pages of a tagged file received by a digital document editing computing system.

Continuing with the above example, the memory thread 240b determines that the same or similar document content data is associated with the memory location data 356a, and further determines that the memory thread 240a has set an indicator to show that data processing is being performed using the memory location data 356a. Responsive to determining that the indicator is set for the memory location data 356a, the memory thread 240b stops or pauses data processing operations on the same or similar document content data. In some cases, the memory thread 240b determines that the indicator is lifted, e.g., data processing is no longer being performed using the memory location data 356a. Responsive to determining that the indicator is lifted for the memory location data 356a, the memory thread 240b accesses a processed version of the same or similar document content data, such as an image (or other content data) that has been processed by the memory thread 240a. In this example, the memory thread 240b can reduce or eliminate redundant operations related to the same or similar document content data, such as by stopping or pausing operations responsive to determining that the indicator is set, or by accessing a processed version of document content data responsive to determining that the indicator is lifted.

In FIG. 2, the digital document editing computing system 220 generates or modifies the hierarchical document file 245 via the memory thread 240a, such as by one or more operations which cause the memory thread 240a to perform data processing of the input document file 225. Additionally or alternatively, the digital document editing computing system 220 allocates to the memory thread 240a the input document file 225 and one or more associated portions of the memory location data structure 350 or the graph data structure 335. For example, the memory thread 240a accesses a subset of nodes in the graph data structure 335 that are associated with the input document file 225, such as a subset of nodes including the nodes 324a, 324b, 324c, 326a, 326b, and 326c. Additionally or alternatively, the memory thread 240a accesses a portion of the memory location data structure 350 associated with the subset of nodes, such as the memory location data 354a, 354b, 354c, 356a, 356b, and 356c.

Based on the accessed subset of nodes, the memory thread 240a identifies one or more of document content data or document structure data included in the input document file 225. For example, the memory thread 240a identifies that the nodes 324a, 324b, and 324c are associated with the document structure data 224a, 224b, and 224c. Additionally or alternatively, the memory thread 240a identifies that the nodes 326a, 326b, and 326c are associated with the document content data 226a, 226b, and 226c. In some cases, the memory thread 240a identifies that, within the subset of nodes, the nodes 326a, 326b, and 326c each have a respective association with (e.g., is a child node of) the nodes 324a, 324b, and 324c.

In the digital document editing computing system 220, the memory thread 240a generates one or more data elements based on the document content data or document structure data associated with the subset of nodes. In some cases, the data elements generated by the memory thread 240a are editable data elements, such as data elements including information (e.g., content data, structure data) that can be edited in a document design environment (such as the document design environment 180). Additionally or alternatively, the data elements generated by the memory thread 240a are hierarchical (such as the hierarchical elements 147), such as data elements including hierarchy data. In FIG. 2, the memory thread 240a generates an editable data element 247a, an editable data element 247b, and an editable data element 247c (referred to collectively herein as editable data elements 247). In some cases, the memory thread 240a generates the editable data elements 247 based on document content data and document structure data associated with the subset of nodes 324a, 324b, 324c, 326a, 326b, and 326c. For example, the editable data element 247a is generated based on the nodes 324a and 326a, and includes editable hierarchy data 244a that is based on the document structure data 224a and editable content data 246a that is based on the document content data 226a. Additionally or alternatively, the editable data element 247b is generated based on the nodes 324b and 326b, and includes editable hierarchy data 244b that is based on the document structure data 224b and editable content data 246b that is based on the document content data 226b. Additionally or alternatively, the editable data element 247c is generated based on the nodes 324c and 326c, and includes editable hierarchy data 244c that is based on the document structure data 224c and editable content data 246c that is based on the document content data 226c. In some cases, the memory thread 240a generates one or more additional editable data elements in the hierarchical document file 245, such as additional editable data elements based on additional nodes in the graph data structure 335.

In the hierarchical document file 245, each portion of editable hierarchy data in the hierarchical document file 245 indicates at least one hierarchical relationship among the editable data elements in the hierarchical document file 245. In some cases, each portion of editable content data in the hierarchical document file 245 is displayed in a visual arrangement (e.g., via a document design environment ) that is determined based on hierarchical relationships indicated by the editable hierarchy data in the hierarchical document file 245. For example, the editable hierarchy data 244a, 244b, and 244c indicate hierarchical relationships among the editable data elements 247 (or other editable data elements in the hierarchical document file 245). Additionally or alternatively, the editable content data 246a, 246b, and 246c (or other editable content data in the hierarchical document file 245) are displayed in a visual arrangement that is determined based on the editable hierarchy data 244a, 244b, and 244c. As an example, the editable content data 246a could include a paragraph of text data, the editable content data 246b could include first image data, and the editable content data 246c could include second image data. In addition, the editable hierarchy data 244a could indicate a first hierarchical relationship of the editable data element 247a with the editable data element 247b and a second hierarchical relationship of the editable data element 247a with the editable data element 247c. In this example, the first hierarchical relationship indicates that the editable content data 246a has a relatively higher hierarchical level as compared to the editable content data 246b and the second hierarchical relationship indicates that the editable content data 246a has a relatively lower hierarchical level as compared to the editable content data 246c. In this example, responsive to the first and second hierarchical relationships indicated by the editable hierarchy data 244a, a document design environment that displays the hierarchical document file 245 displays a visual arrangement in which the editable content data 246a is visually above (e.g., appears to be closer to a user) the editable content data 246b and is visually below (e.g., appears to be farther from the user) the editable content data 246c. In this example visual arrangement, the document design environment displays the paragraph of text data as obscuring (e.g., appears to be closer) at least a portion of the first image data and as being obscured by (e.g., appears to be farther) at least a portion of the second image data.

In FIG. 2, the memory thread 240a generates the hierarchical document file 245 including at least the editable data elements 247. In some cases, one or more of the memory threads 240 generate additional hierarchical document files, such as based on additional input document files allocated to the memory threads 240 by the digital document editing computing system 220. Additionally or alternatively, the digital document editing computing system 220 combines the hierarchical document file 245 with one or more of the additional hierarchical document files to generate a combined hierarchical document file, such as the combined hierarchical document file 150. For example, the digital document editing computing system 220 could include the hierarchical document file 245 as a digital page included in the combined hierarchical document file. In some cases, on or more of the editable hierarchy data 244a, 244b, or 244c indicates one or more hierarchical relationships with additional editable data elements included in the additional hierarchical document files, e.g., relationships of multiple editable data elements included in various pages of the combined hierarchical document file.

In some cases, the digital document editing computing system 220 provides the hierarchical document file 245 (or a combined hierarchical document file that is based on the hierarchical document file 245) to one or more additional computing devices, such as a user computing device. In some cases, the digital document editing computing system 220 provides the hierarchical document file 245 in response to one or more user inputs via the user computing device. For example, the digital document editing computing system 220 could generate the hierarchical document file 245 in response to a document conversion editing function indicated by an input to a document design environment implemented on a user computing device, such as an input to the document design environment 180 implemented on the computing device 190. Additionally or alternatively, the digital document editing computing system 220 could provide the hierarchical document file 245 (or the combined hierarchical document file based on the hierarchical document file 245) to the document design environment from which the user input was received, such as the document design environment 180 implemented on the computing device 190.

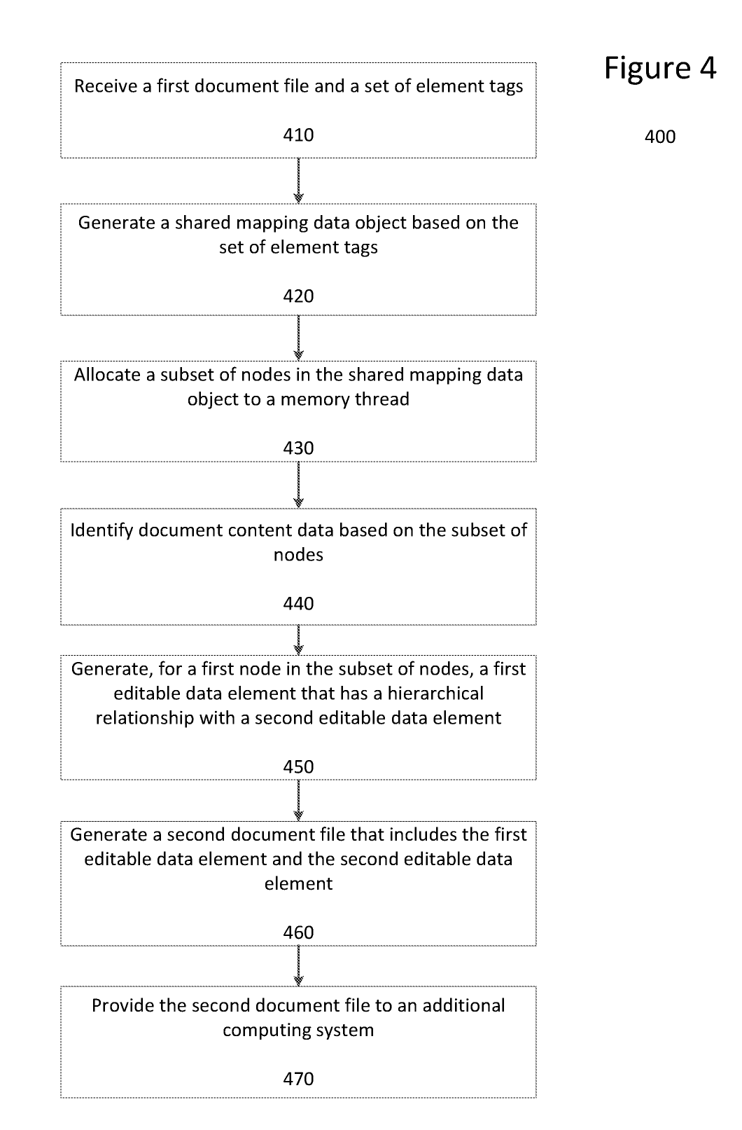

FIG. 4 is a flow chart depicting an example of a process 400 for generating a document that has a hierarchical file type. In some embodiments, such as described in regards to FIGS. 1-3, a computing device executing a digital document editing computing system implements operations described in FIG. 4, by executing suitable program code. For illustrative purposes, the process 400 is described with reference to the examples depicted in FIGS. 1-3. Other implementations, however, are possible.

At block 410, the process 400 involves receiving, such as by a digital document editing computing system, at least one input document file and a set of element tags, such as a first document file and a set of element tags associated with the first document file. In some cases, the first document file has a first file type that lacks hierarchy information or has incomplete hierarchy information (e.g., a .PDF file type). Additionally or alternatively, the set of element tags describes data elements, such as non-editable data elements, included in the first document file. For example, the digital document editing computing system 120 receives the tagged document 115 that includes non-editable data elements and element tags associated with the non-editable data elements. In some cases, the first document file is an untagged document, such as the untagged document 197, from which the example digital document editing computing system determines the set of element tags, such as via one or more machine-learning models included in the digital document editing computing system.

At block 420, the process 400 involves generating, by the digital document editing computing system, a shared mapping data object. In some cases, the digital document editing computing system generates the shared mapping data object based on the set of element tags. Additionally or alternatively, the digital document editing computing system generates the shared mapping data object based on a combination of the set of element tags with at least one data element included in the first document file. For example, the digital document editing computing system 220 generates the shared mapping data object 235 based on a combination of the element tags 223 with the data elements 227. In some cases, the digital document editing computing system generates the shared mapping data object based on multiple sets of element tags associated with multiple document files. For example, the digital document editing computing system 120 generates the shared mapping data object 135 based on the element tags 123 associated with the data elements 127 and the input document files 125.

In some implementations, the shared mapping data object generated by the digital document editing computing system includes one or more nodes. Additionally or alternatively, each node of the shared mapping data object includes one or more of document structure data or memory location data. In some cases, the digital document editing computing system extracts the document structure data from one or more data elements included in the first document file. In some cases, the digital document editing computing system determines the memory location data based on one or more memory locations of the extracted document structure data. For example, the memory 230 extracts document structure data 224a, 224b, and 224c from the input document file 225 and includes the extracted document structure data 224a, 224b, and 224c in, respectively, the nodes 324a, 324b, and 324c. Additionally or alternatively, the memory 230 determines the memory location data 354a, 354b, and 354c indicating respective memory locations (e.g., registers) of the extracted document structure data 224a, 224b, and 224c and includes the memory location data 354a, 354b, and 354c in, respectively, the nodes 324a, 324b, and 324c.

At block 430, the process 400 involves allocating, by the digital document editing computing system, a subset of nodes in the shared mapping data object, such as a subset of nodes that is allocated to a particular memory thread in a memory component of the digital document editing computing system. In some cases, the subset of nodes is associated with a particular portion (e.g., a digital page) of the at least one input document files, such a subset of nodes associated with the first document file. For example, the digital document editing computing system 220 allocates to the memory thread 240a a subset of nodes associated with the input document file 225, such as the subset of nodes 324a, 324b, 324c, 326a, 326b, and 326c. In some cases, the digital document editing computing system allocates multiple subsets of nodes to various memory threads in a group of memory threads, such as a particular subset of nodes associated with a particular page (or other portion) of the at least one input document files. In the digital document editing computing system 220, for example, the memory thread 240a is allocated the subset of nodes 324a, 324b, 324c, 326a, 326b, and 326c associated with the input document file 225 and the memory thread 240b is allocated an additional subset of nodes associated with an additional input document file received by the digital document editing computing system 220. In some cases, a memory thread is allocated multiple subsets of nodes associated with multiple input document files. For example, the digital document editing computing system 220 could utilize equivalent allocation techniques, overloaded allocation techniques, or other allocation techniques to allocate multiple subsets of nodes to one or more of the memory threads 240.

At block 440, the process 400 involves identifying, by the particular memory thread in the digital document editing computing system, document content data that is based on the allocated subset of nodes. In some cases, the particular memory thread identifies the document content data as being included in the first document file, such as being included on a first page (or other portion) of the at least one input document files. Additionally or alternatively, the particular memory thread identifies the document content data based on data in at least one node of the subset of nodes, such as document content data that is stored at a memory location indicated by memory location data in a particular node. For example, based on the memory location data 356a, 356b, and 356c, the memory thread 240a identifies the document content data 226a, 226b, and 226c from the input document file 225.

In some cases, operations related to block 440 are repeated for multiple subsets of nodes. For example a particular memory thread could identify respective document content data for multiple subsets of nodes that are allocated to the particular memory thread. Additionally or alternatively, multiple memory threads in a group of memory threads could identify respective document content data for respective subsets of nodes that are allocated respectively to each of the multiple memory threads. In the digital document editing computing system 220, for example, the memory thread 240a identifies the document content data 226a, 226b, and 226c based on the subset of nodes 324a, 324b, 324c, 326a, 326b, and 326c and the memory thread 240b identifies additional document content data based on the additional subset of nodes associated with the additional input document file.

At block 450, the process 400 involves generating, by the particular memory thread in the digital document editing computing system, one or more data elements. In some cases, the data elements are editable data elements that can be modified via a document design environment (such as the document design environment 180). Additionally or alternatively, the data elements are hierarchical data elements, such as data elements that include hierarchy data indicating hierarchical relationships among the data elements. For example, the particular memory thread generates a first editable data element that is associated with a first node in the allocated subset of nodes. In some cases, the particular memory thread includes in the first editable data element one or more of first document content data or first document structure data. Additionally or alternatively, the first document content data and the first document structure data are associated, such as an association determined (e.g., by the particular memory thread) based on the first node in the allocated subset of nodes. For example, the memory thread 240a generates the editable data element 247a which includes the editable content data 246a and the editable hierarchy data 244a.

In some cases, the first editable data element has a particular hierarchical relationship with (at least) a second editable data element generated by the particular memory thread in the digital document editing computing system, such as a second editable data element associated with a second node in the allocated subset of nodes. For example, the first editable data element includes (or is otherwise associated with) the first document structure data and the second editable data element includes (or is otherwise associated with) second document structure data. Additionally or alternatively, one or more of the first document structure data or the second document structure data indicates the particular hierarchical relationship between the first editable data element and the second editable data element. For example, one or more of the editable hierarchy data 244a, 244b, or 244c indicates at least one hierarchical relationship among the editable data elements 247a, 247b, and 247c. In this example, the first editable data element and the second editable data element are generated by a same memory thread in the digital document editing computing system, such as the particular memory thread, but other implementations are possible. For example, the first editable data element and the second editable data element could be generated by different memory threads in the digital document editing computing system, such as the particular memory thread generating the first editable data element and an additional memory thread generating the second editable data element.

In some cases, operations related to block 450 are repeated for multiple subsets of nodes. For example a particular memory thread could generate respective editable data elements for multiple subsets of nodes that are allocated to the particular memory thread. Additionally or alternatively, multiple memory threads in a group of memory threads could generate respective editable data elements for respective subsets of nodes that are allocated respectively to each of the multiple memory threads.

At block 460, the process 400 involves generating, by the particular memory thread in the digital document editing computing system, a second document file. In some cases, the second document file has a second file type that includes hierarchy information (e.g., a .INDD file type). In some cases, the second document file includes the first editable data element and the second editable data element. Additionally or alternatively, the second document file indicates the particular hierarchical relationship of the first editable data element with the second editable data element, such as via editable hierarchy data included in one or more of the first editable data element or the second editable data element. For example, the memory thread 240a generates the hierarchical document file 245 that includes the editable data elements 247a, 247b, and 247c. Additionally or alternatively, the hierarchical document file 245 indicates at least one hierarchical relationship among the editable data elements 247a, 247b, and 247, such as via one or more of the editable hierarchy data 244a, 244b, or 244c.

In some cases, operations related to block 460 are repeated for multiple subsets of nodes. For example a particular memory thread could generate respective hierarchical document files for multiple subsets of nodes that are allocated to the particular memory thread. Additionally or alternatively, multiple memory threads in a group of memory threads could generate respective hierarchical document files for respective subsets of nodes that are allocated respectively to each of the multiple memory threads.

At block 470, the process 400 involves providing, by the digital document editing computing system, the second document file to at least one additional computing system. In some cases, the digital document editing computing system provides the second document file with one or more additional document files, such as in a combined hierarchical document file that is based on hierarchical document files generated by multiple memory threads in the digital document editing computing system. In some cases, the additional computing system implements a document design environment that is configured to present the second document file (or combined hierarchical document file that is based on the second document file). Additionally or alternatively, the document design environment is configured to present the first editable data element and the second editable data element in a visual arrangement that is determined based on the particular hierarchical relationship of the first and second editable data elements. For example, the digital document editing computing system 220 provides the hierarchical document file 245 to the computing device 190 that includes the document design environment 180. In this example, the document design environment 180 displays (or otherwise provides) the hierarchical document file 245 based on hierarchical relationships of the editable data elements 247, such as modifying the user interface 195 to display the editable content data 246a, 24b, and 246c in a visual arrangement that is determined based on the editable hierarchy data 244a, 244b, and 244c.

In some implementations, a digital document editing computing system can perform one or more operations related to data processing for particular types of document content data. For example, based on one or more of a data element or an element tag included in an input document file, the digital document editing computing system could identify that document content data included in (or otherwise associated with) the data element is one or more of text data, list text data (e.g., bullet data, numbering data), image data, vector path data, font data, or other types of document content data that can be included in an input document file. In some implementations, the digital document editing computing system, or one or more memory threads included in the digital document editing computing system, can perform data processing operations that are based on the particular types of document content data.

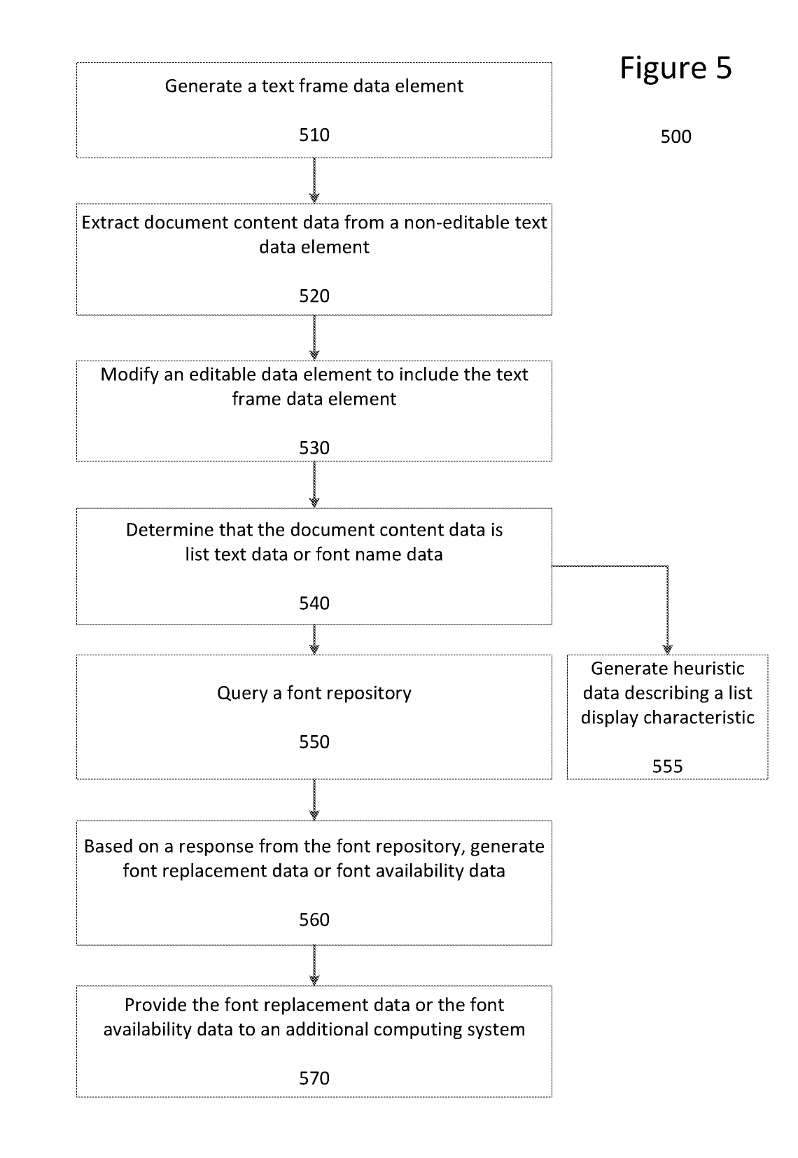

FIG. 5 is a flow chart depicting an example of a process 500 for additional data processing that can be performed during generation of a document that has a hierarchical file type. In FIG. 5, the additional data processing is for a particular type of document content data, such as one or more of text data, font data, or list text data (e.g., bullet data, numbering data). In some embodiments, such as described in regards to FIGS. 1-4, a computing device executing a digital document editing computing system implements operations described in FIG. 5, by executing suitable program code. For illustrative purposes, the process 500 is described with reference to the examples depicted in FIGS. 1-4. Other implementations, however, are possible.

In some cases, one or more operations included in the process 500 are implemented in combination with one or more operations included in the process 400, at least. For example, a digital document editing computing system (or one or more memory threads included in the digital document editing computing system) could implement one or more operations included in the process 500, such as subsequent to (or otherwise in relation to) generating a shared mapping data object, allocating a subset of nodes, or identifying document content data based on the subset of nodes, e.g., in regard to one or more of blocks 420, 430, or 440. Additionally or alternatively, the digital document editing computing system (or one or more memory threads included in the digital document editing computing system) could implement other combinations of operations regarding the processes 400 and 500.

At block 510, the process 500 involves generating, by a digital document editing computing system (such as the example digital document editing computing system described in regard to FIG. 4), one or more text frame data elements, e.g., data elements that are configured to contain text data. In some cases, the digital document editing computing system generates a text frame data element responsive to determining that a first node in a shared mapping data object, such as the shared mapping data object described in regard to the process 400, is associated with a first element tag describing a non-editable text data element. Additionally or alternatively, the digital document editing computing system generates or modifies the shared mapping data object to include the text frame data element, such as in first document structure data associated with the first node or the first element tag. For example, the digital document editing computing system 220 determines that at least one node in the graph data structure 335, such as the node 324a, is associated with an element tag, such as the element tag 223a, that describes a non-editable text element. Responsive to determining that the node 324a is associated with the element tag 223a describing the non-editable text element, the digital document editing computing system 220 generates at least a portion of the shared mapping data object 235 that includes a text frame data element. For example, the digital document editing computing system 220 generates the text frame data element, such as a text frame data element included in the document structure data 224a that is stored at a location in the memory 230 indicated by the memory location data 354a.

In some implementations, the digital document editing computing system or at least one memory thread included in the digital document editing computing system determines that the first document structure data includes the text frame data element. For example, a particular memory thread in the digital document editing computing system (such as the particular memory thread described in regard to FIG. 4) determines that the text frame data element is included in the first document structure data associated with the first node, such as a determination based on the first node being included in a subset of nodes allocated to the particular memory thread. For example, the memory thread 240a determines that the node 324a indicates the memory location data 354a, at which the document structure data 224a, e.g., including the text frame data element, is stored.

At block 520, the process 500 involves extracting, by the particular memory thread in the digital document editing computing system, first document content data that is included in the non-editable text data element that is described by the first element tag. In some cases, the first document content data is included in (or otherwise associated with) an additional node in the shared mapping data object. For example, based on the graph data structure 335 including the node 324a and the node 326a the memory thread 240a extracts the document content data 226a from the data element 227a.

At block 530, the process 500 involves modifying, by the particular memory thread in the digital document editing computing system, at least one editable data element to include one or more of the text frame data element or the first document content data. In some cases, the particular memory thread modifies the first editable data element, described in regard to FIG. 4, to include the text frame data element or the first document content data. Additionally or alternatively, the particular memory thread determines a text arrangement of the first document content data within the text frame data element, such as based on the first document structure data. For example, the memory thread 240a modifies the editable data element 247a to include, such as in the editable content data 246a, text data extracted from the document content data 226a. Additionally or alternatively, the memory thread 240a modifies the editable data element 247a to describe, such as in the editable hierarchy data 244a, an arrangement of the text data that is determined based on the document structure data 224a, e.g., an arrangement of the text data within a text frame data element.

In some implementations, the digital document editing computing system generates at least one document file, such as the second document file or the combined hierarchical document file described in regard to FIG. 4, based on the first editable data element that includes the text frame data element. Additionally or alternatively, the particular memory thread determines that the text frame data element has at least one hierarchical relationship with at least one additional editable data element in the at least one document file, such as the particular hierarchical relationship of the first editable data element with the second editable data element described in regard to FIG. 4. For example, the memory thread 240a determines that the editable data element 247a has respective hierarchical relationships with one or more of the editable data elements 247b and 247c, such that the example arrangement of text data in the editable data element 247a has the respective hierarchical relationships with additional document content data, e.g., included in the editable content data 246b and 246c.

At block 540, the process 500 involves determining, by the particular memory thread in the digital document editing computing system, that the first document content data extracted from the non-editable text data element is one or more of list text data or font name data. Examples of list text data can include bullet data (e.g., data describing shapes, sizes, or other characteristics of list bullets), numbering data (e.g., data describing start number, numbering advance value, or other characteristics of list numbers), or other types of data describing a list (e.g., of text). Examples of font name data can include a name of a font (e.g., “Arial,” “Garamond”), a characteristic of a font (e.g., “sans serif”), a characteristic of text depicted by a font (e.g., “Cyrillic”, “Unicode”), or other types of data describing a font. For example, the memory thread 240a could determine that the document content data 226a extracted from the data element 227a includes text data that includes (or is otherwise associated with) one or more of list text data or font name data. In this example, the memory thread 240a could determine that the document content data 226a is associated with list text data indicating bullets (e.g., at least some text in the document content data 226a is arranged as a bulleted list) and is also associated with font name data indicating a particular font ( e.g., at least some text in the document content data 226a is of the particular font, such as “Garamond”).

At block 555, the process 500 involves generating, by the particular memory thread in the digital document editing computing system, heuristic data that is associated with the extracted first document content data. In some cases, the particular memory thread generates the heuristic data responsive to determining that the extracted first document content data includes list text data. Additionally or alternatively, the heuristic data describes at least one list display characteristic of the list text data. Examples of list display characteristics can include bullet shapes, bullet sizes, numbering selections (e.g., Arabic numerals, Roman numerals, lettering), a start number (e.g., beginning at 1, beginning at A, beginning at 100), a numbering advance value (e.g., advancing list numbering by an increment of one, advancing list numbering by an increment of five), list level indentation (e.g., indentations indicating subsections of a list), or other types of data describing a display characteristic of a list. In some cases, the text arrangement of the first document content data within the text frame data element is determined based on the heuristic data. For example, responsive to determining that the extracted document content data 226a includes list text data, the memory thread 240a generates heuristic data describing at least one list display characteristic of the extracted document content data 226a. In this example, the memory thread 240a modifies the editable data element 247a to describe an arrangement of the text data that is determined based on, at least, the heuristic data. For instance, if the memory thread 240a determines that the extracted document content data 226a has triangle-shaped bullets, the heuristic data can include a list display characteristic indicating triangular bullets in the editable content data 246a. In some cases, the particular memory thread determines the text arrangement of the first document content data within the text frame data element based on a combination of the first document structure data with the heuristic data. Continuing with the above example, for instance, the memory thread 240a could modify the editable data element 247a based on a combination of the heuristic data with the document structure data 224a, e.g., an arrangement of the text data with triangular bullets within a text frame data element.

At block 550, the process 500 involves querying, by the particular memory thread in the digital document editing computing system, at least one font repository, such as a font repository that is included in or otherwise in communication with (e.g., via one or more network connections) the digital document editing computing system. In some cases, the particular memory thread or the digital document editing computing system queries the font repository responsive to determining that the extracted first document content data includes font name data. Additionally or alternatively, querying the font repository includes providing the font name data to the font repository. For example, the memory thread 240a or the digital document editing computing system 220 could determine that the extracted document content data 226a includes font name data. In this example, the memory thread 240a or the digital document editing computing system 220 could determine that the font name data describes a font that is not available to the digital document editing computing system 220, such as a customized font, a font included in an industry-specific font collection, or other types of fonts not available to the digital document editing computing system 220. Continuing with this example, responsive to determining that the extracted document content data 226a includes font name data not available to the digital document editing computing system 220, the memory thread 240a generates query data, such as query data that includes the font name data. In this example, the digital document editing computing system 220 can provide the query data generated by the memory thread 240a to a font repository that is in communication with the digital document editing computing system 220.

At block 560, the process 500 involves generating, by the particular memory thread in the digital document editing computing system, one or more of font availability data or font replacement data. At block 570, the process 500 involves providing, by the particular memory thread or the digital document editing computing system, one or more of the font availability data or the font replacement data to at least one additional computing system, such as a computing device that implements a document design environment. For example, the memory thread 240a modifies the editable data element 247a to describe an arrangement of the text data that is determined based on one or more of font availability data or font replacement data. Additionally or alternatively, the digital document editing computing system 220 provides to the computing device 190 one or more of the font availability data or the font replacement data, such as to alert a user of the document design environment 180 whether a font associated with the input document file 225 is available, e.g., via the font availability data, or whether a replacement font could be used to replace or augment the font associated with the input document file 225, e.g., via the font replacement data.

In some implementations, the particular memory thread generates the font availability data or the font replacement data based on a response that is received from the font repository. Additionally or alternatively, one or more of the font availability data or the font replacement data describes at least one font display characteristic. Examples of font display characteristics can include a name of a font, a characteristic of a font (e.g., “sans serif”), a characteristic of text depicted by a font (e.g., “Cyrillic”, “Unicode”), or other types of data describing a font. In some implementations, the font availability data or the font replacement data, e.g., which are based on the response from the font repository, can be used by the digital document editing computing system or the particular memory thread to replace or augment the font name data extracted from the first document content data, such as to replace or augment a font that is not available to the digital document editing computing system.

In some cases, responsive to determining that the response from the font repository indicates a font that is available in the font repository, the particular memory thread generates the font availability data that describes the available font. Additionally or alternatively, the particular memory thread determines the text arrangement of the first document content data within the text frame data element based on the font availability data. For example, responsive to receiving font availability data indicating a font that is available in the font repository, the memory thread 240a modifies the editable data element 247a to describe an arrangement of the text data that is determined based on, at least, the font availability data, e.g. the available font is applied to the text data. In some cases, the particular memory thread determines the text arrangement of the first document content data within the text frame data element based on a combination of the first document structure data with the font availability data. Continuing with the above example, for instance, the memory thread 240a could modify the editable data element 247a based on a combination of the font availability data with the document structure data 224a, e.g., an arrangement of the text data in the available font within a text frame data element.

In some cases, the response from the font repository indicates that a font described by the query data is not available in the font repository. Additionally or alternatively, the response from the font repository indicates one or more additional fonts that are available, such as additional font name data or additional font display characteristics. In some cases, responsive to determining that the response from the font repository indicates that the font described by the query data is not available, the particular memory thread generates the font replacement data that describes the additional fonts. Additionally or alternatively, the particular memory thread or the digital document editing computing system provides the font replacement data to the at least one additional computing system. In some cases, the additional computing system is configured to present, such as via the document design environment, at least one user interface control component (e.g., a selection interface) based on the font replacement data. For example, the computing device 190 presents a selection interface to a user of the document design environment 180, such that the user can select one or more fonts to replace or augment a font that is not available to the digital document editing computing system 220.

Additionally or alternatively, the particular memory thread or the digital document editing computing system receives font selection data from the additional computing system. In some cases, the font selection data indicates at least one input to the user interface control component, e.g., a user’s selection of a particular one of the additional fonts that are available. Based on the font selection data, the particular memory thread or the digital document editing computing system generates or modifies the font availability data. Additionally or alternatively, the particular memory thread determines (or modifies) the text arrangement of the first document content data within the text frame data element based on the font availability data, e.g. as modified based on the font selection data. For example, the memory thread 240a modifies the editable data element 247a to describe an arrangement of the text data that is determined based on, at least, the font availability data that is based on the font selection data, e.g., the editable data element 247a describes an arrangement of the text data in the available font that is selected by the user of the document design environment 180.

In some implementations, the particular memory thread or the digital document editing computing system generates at least one document file, such as the second document file described in regard to FIG. 4, based on one or more of the font availability data or the font replacement data. Additionally or alternatively, the generated document file includes the arrangement of the text data that is determined based on one or more of the font availability data or the font replacement data. For example, the memory thread 240a generates (or modifies) the hierarchical document file 245 to include an available font or a replacement font, such as an arrangement of the text data described by the editable data element 247a. Additionally or alternatively, the digital document editing computing system 220 provides to the computing device 190 the hierarchical document file 245, which includes the editable data element 247a as generated (or modified) by the memory thread 240a. In some cases, the document design environment 180 is configured to display a visual arrangement of the editable data element 247a, such as a visual arrangement determined based on at least one hierarchical relationship indicated by the editable hierarchy data 244c and one or more of the available font or the replacement font, e.g., one or more fonts indicated by the font availability data or the font replacement data.

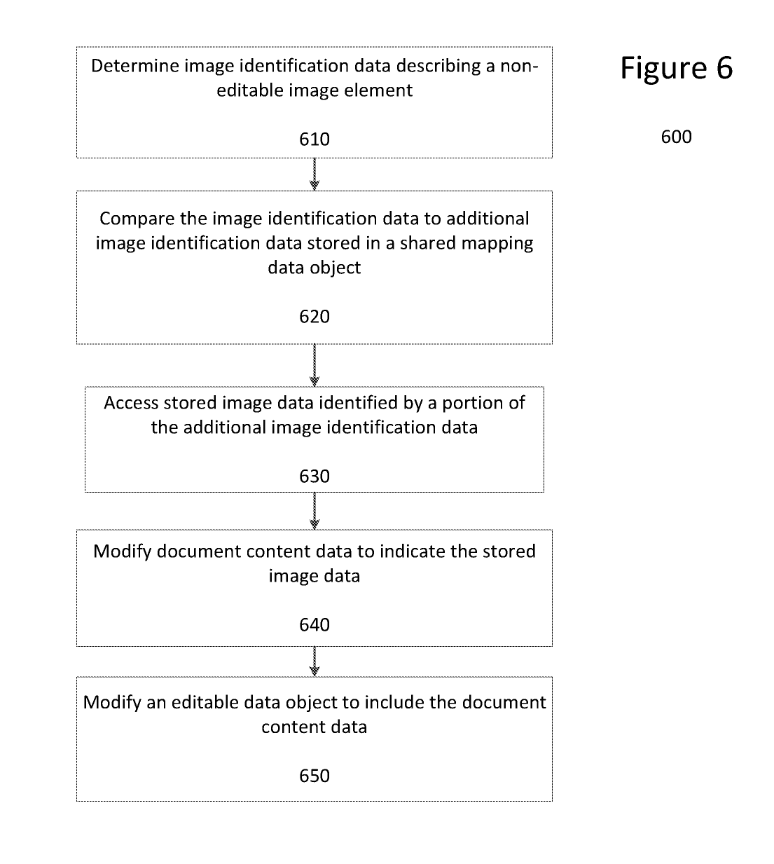

FIG. 6 is a flow chart depicting an example of a process 600 for additional data processing that can be performed during generation of a document that has a hierarchical file type. In FIG. 6, the additional data processing is for a particular type of document content data, such as image data. In some embodiments, such as described in regards to FIGS. 1-5, a computing device executing a digital document editing computing system implements operations described in FIG. 6, by executing suitable program code. For illustrative purposes, the process 600 is described with reference to the examples depicted in FIGS. 1-5. Other implementations, however, are possible.

In some cases, one or more operations included in the process 600 are implemented in combination with one or more operations included in the process 400, at least. For example, a digital document editing computing system (or one or more memory threads included in the digital document editing computing system) could implement one or more operations included in the process 600, such as subsequent to (or otherwise in relation to) generating a shared mapping data object, allocating a subset of nodes, or identifying document content data based on the subset of nodes, e.g., in regard to one or more of blocks 420, 430, or 440. Additionally or alternatively, the digital document editing computing system (or one or more memory threads included in the digital document editing computing system) could implement other combinations of operations regarding the processes 400 and 600.

At block 610, the process 600 involves determining, by a particular memory thread in a digital document editing computing system (such as the digital document editing computing system or the particular memory thread described in regard to FIG. 4), image identification data. In some cases, the image identification data describes a non-editable image data element. Additionally or alternatively, the particular memory thread determines the image identification data responsive to determining that a first node in a shared mapping data object, such as the shared mapping data object described in regard to the process 400, is associated with a first element tag describing the non-editable image data element. For example, the memory thread 240a determines that at least one node in the graph data structure 335, such as the node 324b, is associated with an element tag, such as the element tag 223b, that describes a non-editable image element. Responsive to determining that the node 324b is associated with the element tag 223b describing the non-editable image element, the memory thread 240a generates or otherwise determines image identification data describing the non-editable image element.

At block 620, the process 600 involves comparing, by the particular memory thread in the digital document editing computing system, the image identification data to additional image identification data, such as additional image identification data stored in the shared mapping data object. In some cases, the additional image identification data is associated with an additional document file that is allocated to another memory thread in the digital document editing computing system. For example, the memory thread 240a compares the image identification data associated with the node 324b with additional image identification data associated with an additional node in the shared mapping data object 235. In some cases, the memory thread 240a compares the image identification data to additional image identification data associated with an additional input document file, such as an additional input document file allocated to the memory thread 240b.

At block 630, the process 600 involves accessing, by the particular memory thread in the digital document editing computing system, stored image data that is identified by the additional image identification data, such as stored image data stored in the shared mapping data object. In some cases, the particular memory thread accesses the stored image data responsive to determining that the image identification data matches (or otherwise corresponds to) the additional image identification data. For example, the memory thread 240a determines that the image identification data associated with the node 324b matches the additional image identification data associated with the additional node, e.g., the image identification data and the additional image identification data describe a same or similar image. Responsive to determining the match, the memory thread 240a accesses stored image data described by the additional image identification data, such as stored image data at a memory location described by the additional node in the shared mapping data object 235. In some cases, the particular memory thread identifies an indicator, such as a flag set in the shared mapping data object, that indicates the stored image data is being processed, such as image processing by an additional thread in the digital document editing computing system.

In some implementations, the particular memory thread determines, based on the comparing (e.g., described in regard to block 620), that the image identification data and the additional image identification data do not match, or otherwise lack correspondence. In this example, the particular memory thread can begin processing of image data associated with the image identification data. Additionally or alternatively, the particular memory thread can access the shared mapping data object to set an indicator (e.g., a flag) to indicate that the image data is being processed by the particular memory thread.

At block 640, the process 600 involves modifying, by the particular memory thread in the digital document editing computing system, document content data to indicate the stored image data. In some cases, the particular memory thread modifies the first document content data, such as described in regard to the process 400, to indicate the stored image data. In some cases, the particular memory thread modifies the first document content data responsive to determining that the image identification data matches (or otherwise corresponds to) the additional image identification data. For example, responsive to determining the match between the image identification data associated with the node 324b and the additional image identification data associated with the additional node, the memory thread 240a generates or modifies the editable content data 246b to indicate the stored image data.

At block 650, the process 600 involves modifying, by the particular memory thread in the digital document editing computing system, one or more data elements to include the document content data, such as the first document content data. Additionally or alternatively, the particular memory thread determines an image arrangement of the document content data, such as an image arrangement that is based on document structure data included in the one or more data elements. For example, the memory thread 240a modifies the editable data element 247b to indicate, such as by the editable content data 246b, the stored image data. Additionally or alternatively, the memory thread 240a modifies the editable data element 247b to describe, such as in the editable hierarchy data 244b, an arrangement of the stored image data that is determined based on the document structure data 224b. In some implementations, multiple data elements in a document file can indicate particular stored image data, such as multiple pages of a hierarchical document file that depict a particular image. For example, the editable data element 247b in the hierarchical document file 245 may indicate a same image, e.g., in the stored image data, as additional editable data elements on additional pages of a combined hierarchical document file.

In some implementations, the particular memory thread or the digital document editing computing system generates at least one document file, such as the second document file described in regard to FIG. 4, based on the stored image data. Additionally or alternatively, the generated document file includes the image arrangement that is determined based on one or more of the stored image data or the document structure data. For example, the memory thread 240a generates (or modifies) the hierarchical document file 245 to indicate the stored image data, such as an image arrangement described by the editable data element 247b. Additionally or alternatively, the digital document editing computing system 220 provides to the computing device 190 the hierarchical document file 245, which includes the editable data element 247b as generated (or modified) by the memory thread 240a. In some cases, the document design environment 180 is configured to display a visual arrangement of the editable data element 247b, such as a visual arrangement determined based on a combination of the stored image data indicated by the editable content data 246b and at least one hierarchical relationship indicated by the editable hierarchy data 244b.

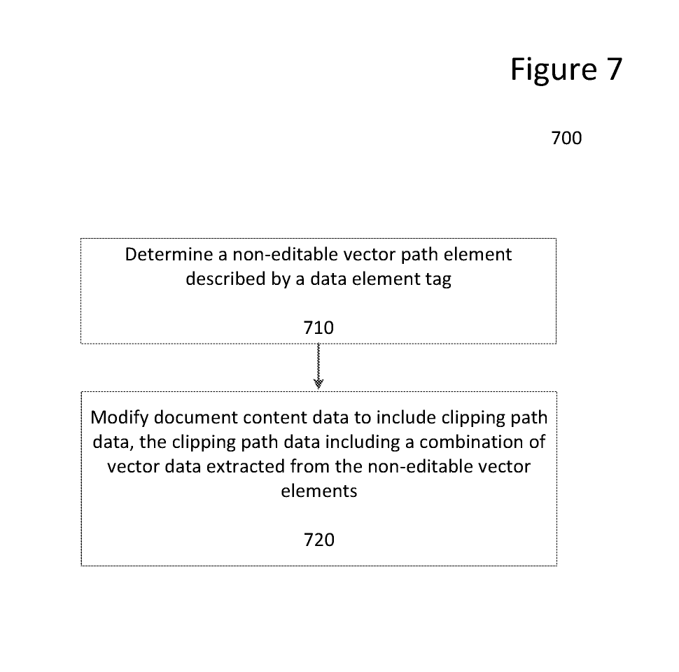

FIG. 7 is a flow chart depicting an example of a process 700 for additional data processing that can be performed during generation of a document that has a hierarchical file type. In FIG. 7, the additional data processing is for a particular type of document content data, such as vector path data. In some embodiments, such as described in regards to FIGS. 1-6, a computing device executing a digital document editing computing system implements operations described in FIG. 7, by executing suitable program code. For illustrative purposes, the process 700 is described with reference to the examples depicted in FIGS. 1-6. Other implementations, however, are possible.

In some cases, one or more operations included in the process 700 are implemented in combination with one or more operations included in the process 400, at least. For example, a digital document editing computing system (or one or more memory threads included in the digital document editing computing system) could implement one or more operations included in the process 700, such as subsequent to (or otherwise in relation to) generating a shared mapping data object, allocating a subset of nodes, or identifying document content data based on the subset of nodes, e.g., in regard to one or more of blocks 420, 430, or 440. Additionally or alternatively, the digital document editing computing system (or one or more memory threads included in the digital document editing computing system) could implement other combinations of operations regarding the processes 400 and 700.

At block 710, the process 700 involves determining, by a particular memory thread in a digital document editing computing system (such as the digital document editing computing system or the particular memory thread described in regard to FIG. 4), that a first node is associated with a first element tag describing a vector path data element. In some cases, the first node is included in a shared mapping data object, such as the shared mapping data object described in regard to the process 400. Responsive to determining that the first node is associated with the first element tag describing the vector path data element, the particular memory thread determines one or more additional vector path data elements. In some cases, one or more of the vector path data element or the additional vector path data elements are non-editable vector path data elements. For example, the memory thread 240a determines that at least one node in the graph data structure 335, such as the node 324c, is associated with an element tag, such as the element tag 223c, that describes a non-editable vector path data element. Responsive to determining that the node 324c is associated with the element tag 223c describing the non-editable vector path data element, the memory thread 240a determines one or more additional non-editable vector path data elements described by additional element tags, such as additional element tags included in the input document file 225.

At block 720, the process 700 involves modifying, by the particular memory thread in the digital document editing computing system, document content data to include (or otherwise indicate) clipping path data. In some cases, the particular memory thread modifies the first document content data, such as described in regard to the process 400, to include the clipping path data. Additionally or alternatively, the clipping path data is generated, such as by the particular thread, based on a combination of vector path data extracted from the vector path data element and at least one of the additional vector path data elements. For example, based on determining that the element tag 223c and the additional element tags describing the non-editable vector path data element and additional non-editable vector path data elements, the memory thread 240a extracts vector path data from associated document content data, such as the document content data 226c and additional document content data associated with the additional element tags. Additionally or alternatively, the memory thread 240a generates clipping path data based on a combination of the extracted vector path data, such as by identifying graphical interactions (e.g., overlapping, corner connections) among portions of the extracted vector path data. An example of vector path data can include graphical data that describes a path (e.g., a line, an arc, a curve) from which displayed graphical data can be calculated, such as a set of pixels that are displayed based on the vector path data. An example of clipping path data can include graphical data that describes a path (e.g., a line, an arc, a curve) from which from which masking data can be calculated, such as a graphical mask that prevents display of a set of pixels based on the clipping path data.

In some implementations, the particular memory thread or the digital document editing computing system generates at least one document file, such as the second document file described in regard to FIG. 4, based on the clipping path data included in the document content data. Additionally or alternatively, the generated document file includes an arrangement of editable data elements that is determined based on one or more of the clipping path data or document structure data that is associated with the document content data. In some cases, the arrangement based on the clipping path data can prevent or permit display (e.g., via a user interface device) of additional document content data included in the generated document file. Additionally or alternatively, the clipping path data can prevent or permit display of the additional document content data based on one or more hierarchical relationships among editable data elements included in the generated document file. For example, the memory thread 240a generates (or modifies) the hierarchical document file 245 to indicate the clipping path data, such as an arrangement described by the editable data element 247c. In this example, the editable hierarchy data 244c indicates at least one particular hierarchical relationship of the clipping path data in the editable data element 247c, such as by a first hierarchical relationship with respect to the editable data element 247a and a second hierarchical relationship with respect to the editable content data 246b. Additionally or alternatively, the digital document editing computing system 220 provides to the computing device 190 the hierarchical document file 245, which includes the editable data element 247c as generated (or modified) by the memory thread 240a. In some cases, the document design environment 180 is configured to display a visual arrangement of the editable data element 247c, such as a layered visual arrangement determined based on a combination of the clipping path data indicated by the editable content data 246c and the at least one hierarchical relationship indicated by the editable hierarchy data 244c. Continuing with this example, the document design environment 180 permits display of the editable content data 246a (e.g., the text data described in regard to FIG. 5) responsive to determining the first hierarchical relationship with respect to the editable data element 247a, e.g., the clipping path data does not prevent display of text data in the editable content data 246a. Additionally or alternatively, the document design environment 180 prevents display of a portion of the editable content data 246b (e.g., the image data described in regard to FIG. 6) responsive to determining the second hierarchical relationship with respect to the editable data element 247b, e.g., the clipping path data prevents display of at least a portion of image data in the editable content data 246b.

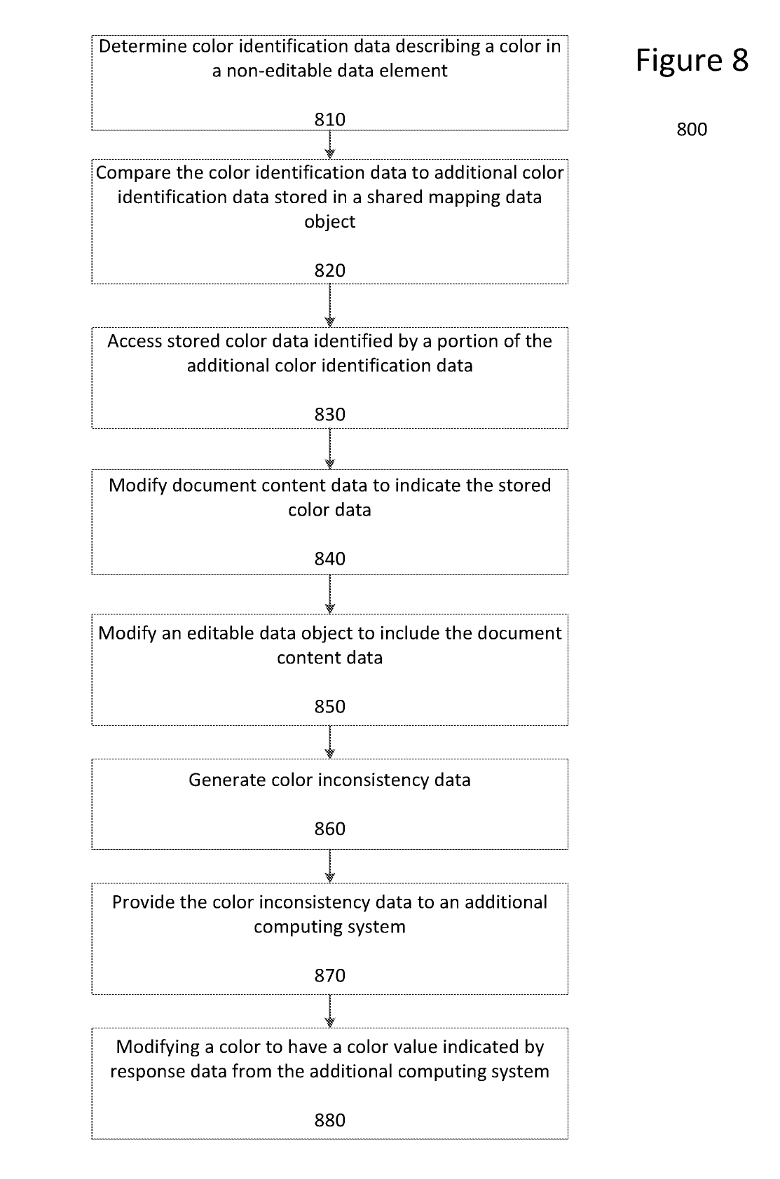

FIG. 8 is a flow chart depicting an example of a process 800 for additional data processing that can be performed during generation of a document that has a hierarchical file type. In FIG. 8, the additional data processing is for a particular type of document content data, such as color data. In some embodiments, such as described in regards to FIGS. 1-7, a computing device executing a digital document editing computing system implements operations described in FIG. 8, by executing suitable program code. For illustrative purposes, the process 800 is described with reference to the examples depicted in FIGS. 1-7. Other implementations, however, are possible.

In some cases, one or more operations included in the process 800 are implemented in combination with one or more operations included in the process 400, at least. For example, a digital document editing computing system (or one or more memory threads included in the digital document editing computing system) could implement one or more operations included in the process 800, such as subsequent to (or otherwise in relation to) generating a shared mapping data object, allocating a subset of nodes, or identifying document content data based on the subset of nodes, e.g., in regard to one or more of blocks 420, 430, or 440. Additionally or alternatively, the digital document editing computing system (or one or more memory threads included in the digital document editing computing system) could implement other combinations of operations regarding the processes 400 and 800.

At block 810, the process 800 involves determining, by a particular memory thread in a digital document editing computing system (such as the digital document editing computing system or the particular memory thread described in regard to FIG. 4), color identification data. In some cases, the color identification data describes at least one color included in a first non-editable data element. Additionally or alternatively, the particular memory thread determines the color identification data responsive to determining that a first node in a shared mapping data object, such as the shared mapping data object described in regard to the process 400, is associated with a first element tag describing the first non-editable data element. For example, the memory thread 240a determines that at least one node in the graph data structure 335, such as the node 324b, is associated with an element tag, such as the element tag 223b, that describes a non-editable data element which includes image data. Responsive to determining that the node 324b is associated with the element tag 223b describing the non-editable data element, the memory thread 240a generates or otherwise determines color identification data describing the non-editable data element, such as at least one color included in the image data.

At block 820, the process 800 involves comparing, by the particular memory thread in the digital document editing computing system, the color identification data to additional color identification data, such as additional color identification data stored in the shared mapping data object. In some cases, the additional color identification data is associated with an additional document file that is allocated to another memory thread in the digital document editing computing system. In some cases, the additional color identification data is associated with an additional data element in a same document file as the first non-editable data element, such as multiple data elements in the first document file described in regard to FIG. 4. For example, the memory thread 240a compares the color identification data associated with the node 324b with additional color identification data associated with at least one additional node in the shared mapping data object 235. In some cases, the at least one additional node is associated with one or more of an additional data element in the input document file 225 or an additional data element in an additional input file received by the digital document editing computing system 220.

At block 830, the process 800 involves accessing, by the particular memory thread in the digital document editing computing system, stored color data that is identified by the additional color identification data, such as stored color data stored in the shared mapping data object. In some cases, the particular memory thread accesses the stored color data responsive to determining that the color identification data matches (or otherwise corresponds to) the additional color identification data. For example, the memory thread 240a determines that the color identification data associated with the node 324b matches the additional color identification data associated with the additional node, e.g., the color identification data and the additional color identification data describe a same or similar color. Responsive to determining the match, the memory thread 240a accesses stored color data described by the additional color identification data, such as stored color data at a memory location described by the additional node in the shared mapping data object 235.

At block 840, the process 800 involves modifying, by the particular memory thread in the digital document editing computing system, document content data to indicate the stored color data. In some cases, the particular memory thread modifies the first document content data, such as described in regard to the process 400, to indicate the stored color data. In some cases, the particular memory thread modifies the first document content data responsive to determining that the color identification data matches (or otherwise corresponds to) the additional color identification data. For example, responsive to determining the match between the color identification data associated with the node 324b and the additional color identification data associated with the additional node, the memory thread 240a generates or modifies the editable content data 246b to indicate the stored color data. In some cases, the first document content data can indicate the stored color data in addition to additional data. For example the editable content data 246b can indicate the stored color data in addition to image data (e.g., the image data described in regard to FIG. 5).

At block 850, the process 800 involves modifying, by the particular memory thread in the digital document editing computing system, one or more data elements to include the document content data, such as the first document content data. Additionally or alternatively, the particular memory thread determines a color arrangement of the document content data, such as a color arrangement that is based on document structure data included in the one or more data elements. For example, the memory thread 240a modifies the editable data element 247b to indicate, such as by the editable content data 246b, the stored color data. Additionally or alternatively, the memory thread 240a modifies the editable data element 247b to describe, such as in the editable hierarchy data 244b, an arrangement of the stored color data that is determined based on the document structure data 224b. In some implementations, multiple data elements in a document file can indicate particular stored color data, such as multiple pages of a hierarchical document file depicting a particular color. For example, the editable data element 247b in the hierarchical document file 245 may indicate a same color, e.g., in the stored color data, as additional editable data elements on additional pages of a combined hierarchical document file.

At block 860, the process 800 involves generating, by the particular memory thread in the digital document editing computing system, color inconsistency data. In some cases, the particular memory thread generates the color inconsistency data responsive to determining the color identification data is within a threshold match with the additional color identification data. An example of a threshold match is a particular color component (e.g., red, blue, green) having a first value in a first color and a second value in a second color, such that the first value and second value of the color component have a difference within a matching threshold range (e.g., a difference greater than 0% and less than 10%). In this example, the first color and the second color are determined to be within a threshold match, e.g., the first and second colors are similar but not identical. In some cases, the color inconsistency data generated by the particular memory thread indicates that the first color is identified by the color identification data and the second color is identified by the additional color identification data. Additionally or alternatively, the particular memory thread generates input request data identifying the difference between the first color and the second color. For example, the memory thread 240a generates color inconsistency data responsive to determining that the color identification data describing the stored color data is within a threshold match of the additional color identification data describing additional stored color data. Additionally or alternatively, the memory thread 240a generates input request data identifying the difference between the stored color data and the additional stored color data.

At block 870, the process 800 involves providing, by the particular memory thread or the digital document editing computing system, the input request data to at least one additional computing system, such as a computing device that implements a document design environment. In some cases, the additional computing system is configured to modify at least one user interface device, such as a display device, to display the color inconsistency data. For example, the digital document editing computing system 220 provides to the computing device 190 the color inconsistency data, such as to alert a user of the document design environment 180 that the first and second colors are within the threshold match.

At block 880, the process 800 involves modifying, by the particular memory thread in the digital document editing computing system, one or more of the first color or the second color to have a particular color value. In some cases, the particular memory thread modifies the one or more of the first color or the second color based on color selection data received from the additional computing system. For example, the digital document editing computing system 220 receives color selection data from the computing device 190. Additionally or alternatively, the memory thread 240a modifies a color value of one or more of the first color or the second color, based on a color value indicated by the color selection data. In some cases, the particular memory thread modifies the first color to have a color value of the second color or modifies the second color to have a color value of the first color. In some cases, the particular memory thread modifies the first color and the second color to have an additional color value, such as an additional color value of an additional color indicated by the color selection data.

In some implementations, the particular memory thread or the digital document editing computing system generates at least one document file, such as the second document file described in regard to FIG. 4, based on one or more of the stored color data or modified color data (e.g., for the first or second colors). Additionally or alternatively, the generated document file includes the color arrangement that is determined based on one or more of the stored color data (or modified color data) or the document structure data. For example, the memory thread 240a generates (or modifies) the hierarchical document file 245 to indicate the stored color data, such as a color arrangement described by the editable data element 247b. Additionally or alternatively, the digital document editing computing system 220 provides to the computing device 190 the hierarchical document file 245, which includes the editable data element 247b as generated (or modified) by the memory thread 240a. In some cases, the document design environment 180 is configured to display a visual arrangement of the editable data element 247b, such as a visual arrangement determined based on a combination of the stored color data indicated by the editable content data 246b and at least one hierarchical relationship indicated by the editable hierarchy data 244b.

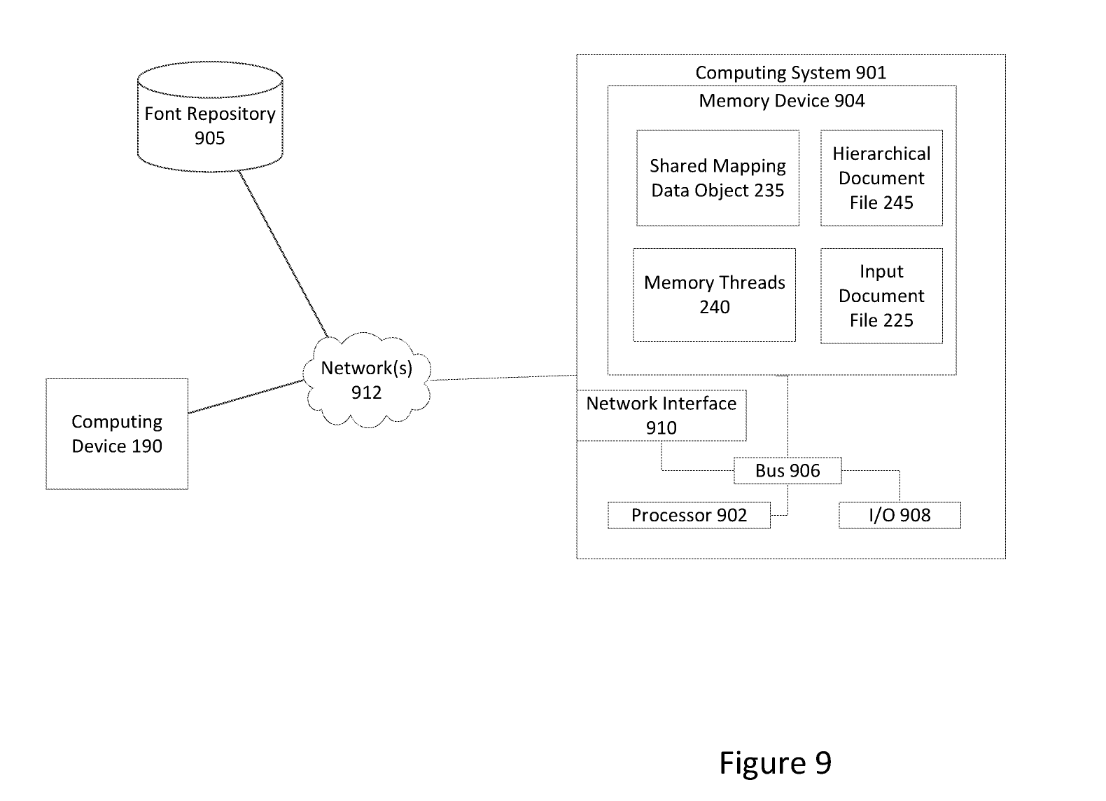

Any suitable computing system or group of computing systems can be used for performing the operations described herein. For example, FIG. 9 is a block diagram depicting an example of a computing system configured for implementing a digital document editing computing system, according to certain embodiments.

The depicted example of a computing system 901 includes one or more processors 902 communicatively coupled to one or more memory devices 904. In some cases, the memory devices 904 can include one or more of the memory 130 or the memory 230. The processor 902 executes computer-executable program code or accesses information stored in the memory device 904. Examples of processor 902 include a microprocessor, an application-specific integrated circuit (“ASIC”), a field-programmable gate array (“FPGA”), or other suitable processing device. The processor 902 can include any number of processing devices, including one.

The memory device 904 includes any suitable non-transitory computer-readable medium for storing the input document file 225, the shared mapping data object 235, the hierarchical document file 245, the memory threads 240, and other received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 901 may also include a number of external or internal devices such as input or output devices. For example, the computing system 901 is shown with an input/output (“I/O”) interface 908 that can receive input from input devices or provide output to output devices. A bus 906 can also be included in the computing system 901. The bus 906 can communicatively couple one or more components of the computing system 901.

The computing system 901 executes program code that configures the processor 902 to perform one or more of the operations described above with respect to FIGS. 1-8. The program code includes operations related to, for example, one or more of the input document file 225, the shared mapping data object 235, the hierarchical document file 245, the memory threads 240, or other suitable applications or memory structures that perform one or more operations described herein. The program code may be resident in the memory device 904 or any suitable computer-readable medium and may be executed by the processor 902 or any other suitable processor. In some embodiments, the program code described above, the input document file 225, the shared mapping data object 235, the hierarchical document file 245, and the memory threads 240 are stored in the memory device 904, as depicted in FIG. 9. In additional or alternative embodiments, one or more of the input document file 225, the shared mapping data object 235, the hierarchical document file 245, the memory threads 240, and the program code described above are stored in one or more memory devices accessible via a data network, such as a memory device accessible via a cloud service.

The computing system 901 depicted in FIG. 9 also includes at least one network interface 910. The network interface 910 includes any device or group of devices suitable for establishing a wired or wireless data connection to one or more data networks 912. Non-limiting examples of the network interface 910 include an Ethernet network adapter, a modem, and/or the like. A font repository 905 is connected to the computing system 901 via the data networks 912, and the font repository 905 can perform some of the operations described herein, such as responding to query data that includes font name data. The computing system 901 is able to communicate with one or more of the font repository 905 or the computing device 190 using the network interface 910.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method for generating a document file, the method comprising:
receiving a first document file and a set of element tags, wherein the set of element tags describes non-editable data elements included in the first document file;
based on the set of element tags, generating a shared mapping data object, in which each node of the shared mapping data object includes at least one of a) document structure data extracted from the non-editable data elements described by the set of element tags and b) memory location data indicating a memory location of the extracted document structure data;
allocating, to a thread implemented via a memory component of a particular computing system, a subset of nodes included in the shared mapping data object, the subset of nodes associated with a particular page of the first document file;
identifying, using the thread, document content data based on the subset of nodes, the document content data being included in the particular page of the first document file and associated with the document structure data included in the subset of nodes;
generating, using the thread, a first editable data element for a first node in the subset of nodes, the first editable data element including first document content data associated with first document structure data of the first node, wherein the first editable data element has a particular hierarchical relationship with a second editable data element for a second node in the subset of nodes;
generating, using the thread, a second document file that includes the first editable data element and the second editable data element having the particular hierarchical relationship; and
providing the second document file to an additional computing system that is configured to display the first editable data element and the second editable data element in a visual arrangement that is based on the particular hierarchical relationship.

2. The method of claim 1, wherein the thread is included in a group of threads executable by the memory component of the particular computing system,
the method further comprising:
allocating, to each additional thread in the group of threads, at least one respective additional subset of nodes included in the shared mapping data object, the at least one additional subset of nodes respectively associated with an additional particular page of the first document file;
generating, using the each additional thread in the group of threads, at least one respective additional second document file that includes at least one additional editable data object including additional document content data associated with additional document structure data of the respective additional subset of nodes; and
generating a combined document file that includes the second document file generated using the thread and the at least one respective additional second document file generated using the each additional thread in the group of threads,
wherein providing the second document file to the additional computing system includes providing the combined document file.

3. The method of claim 2, further comprising:
identifying a first quantity of available threads in the group of threads; and
identifying a second quantity of pages in the first document file, wherein the particular page is included in the second quantity of pages,
wherein allocating, to the thread, the subset of nodes associated with the particular page and allocating, to the each additional thread in the group of threads, the at least one respective additional subset of nodes associated with the additional particular page are based on the first quantity of available threads and the second quantity of pages.

4. The method of claim 1, wherein the non-editable data elements in the first document file include one or more of: text data, list bullet data, list numbering data, vector path data, font data, color data, or image data.

5. The method of claim 1, further comprising:
responsive to determining that the first node is associated with a first element tag that describes a non-editable text data element, generating a text frame data element that is included in the first document structure data of the first node, wherein generating the shared mapping data object comprises generating the text frame data element;
responsive to determining, using the thread, that the first document structure data includes the text frame data element:
extracting, using the thread, the first document content data from the non-editable text data element described by the first element tag; and
modifying, using the thread, the first editable data element to include the text frame data element and the first document content data, wherein the thread determines a text arrangement of the first document content data within the text frame data element based on the first document structure data,
wherein generating the second document file further comprises determining, using the thread, that the text frame data element has the particular hierarchical relationship with second document content data included in the second editable data element,
wherein the visual arrangement displayed by the additional computing system includes the text arrangement of the first document content data within the text frame data element.

6. The method of claim 5, further comprising:
determining, using the thread, that the first document content data extracted from the non-editable text data element is list text data; and
generating, based on the first document content data and using the thread, heuristic data describing at least one list display characteristic,
wherein the text arrangement of the first document content data within the text frame data object is further based on the heuristic data.

7. The method of claim 5, further comprising:
determining, using the thread, that the first document content data extracted from the non-editable text data element includes font name data;
querying, using the thread, a font repository, wherein the querying includes providing the font name data to the font repository; and
generating, using the thread and based on a response received from the font repository, font availability data describing at least one font display characteristic,
wherein the text arrangement of the first document content data within the text frame data object is further based on the font availability data.

8. The method of claim 7, further comprising:
responsive to receiving the response from the font repository, generating font replacement data, wherein the font replacement data indicates a) the font name data, b) additional font name data, and c) input request data identifying the font name data and the additional font name data; and
providing the font replacement data to the additional computing system, wherein the additional computing system is further configured to modify a user interface to display the font replacement data,
wherein generating the font availability data describing the at least one font display characteristic is further based on font selection data received from the additional computing system, the font selection data indicating a selection among the font name data and the additional font name data.

9. The method of claim 1, further comprising:
responsive to determining that the first node is associated with a first element tag that describes a non-editable image data element, determining, using the thread, image identification data that describes the non-editable image data element;
comparing, using the thread, the image identification data to additional image identification data stored in the shared mapping data object;
responsive to determining that the image identification data matches the additional image identification data stored in the shared mapping data object, performing, using the thread:
i) accessing stored image data identified by the additional image identification data, and
ii) modifying the first document content data to indicate the stored image data; and
modifying, using the thread, the first editable data element to include the first document content data, wherein the thread determines an image arrangement of the first document content data based on the first document structure data.

10. The method of claim 1, further comprising:
responsive to determining that the first node is associated with a first element tag that describes a non-editable vector path data element, determining, using the thread, one or more additional non-editable vector path data elements described by additional element tags; and
modifying, using the thread, the first document content data to include clipping path data, wherein the clipping path data includes a combination of vector path data that is extracted from the non-editable vector path data element and the one or more additional non-editable vector path data elements,
wherein the particular hierarchical relationship of the first editable data element with the second editable data element indicates a layered visual arrangement of the clipping path data with respect to second document content data included in the second editable data element.

11. The method of claim 1, further comprising:
responsive to determining that the first node is associated with a first element tag that describes a first non-editable data element that includes a color, determining, using the thread, color identification data that describes the color;
comparing, using the thread, the color identification data to additional color identification data stored in the shared mapping data object;
responsive to determining that the color identification data matches the additional color identification data stored in the shared mapping data object, performing, using the thread:
i) accessing stored color data identified by the additional color identification data, and
ii) modifying the first document content data to indicate the stored color data; and
modifying, using the thread, the first editable data element to include the first document content data, wherein the thread determines a color arrangement of the first document content data based on the first document structure data.

12. The method of claim 11, further comprising:
responsive to determining that the color identification data has a threshold match with the additional color identification data stored in the shared mapping data object, generating color inconsistency data, wherein the color inconsistency data indicates a) a first color identified by the color identification data, b) a second color identified by the additional color identification data, and c) input request data identifying a difference between the first color and the second color;
providing the color inconsistency data to the additional computing system, wherein the additional computing system is further configured to modify a user interface to display the color inconsistency data; and
based on color selection data received from the additional computing system, modifying one or more of the first color or the second color to have a color value indicated by the color selection data.

13. A system for generating a document file, the system comprising:
one or more processors; and
at least one memory component, the at least one memory component having stored thereon instructions that, upon execution by the one or more processors, cause the one or more processors to perform operations comprising:
receiving a first document file and a set of element tags, wherein the set of element tags describes non-editable data elements included in the first document file;
based on the set of element tags, generating a shared mapping data object, in which each node of the shared mapping data object includes at least one of a) document structure data extracted from the non-editable data elements described by the set of element tags and b) memory location data indicating a memory location of the extracted document structure data;
allocating, to a thread implemented via a particular memory component of the at least one memory component, a subset of nodes included in the shared mapping data object, the subset of nodes associated with a particular page of the first document file;
identifying, using the thread, document content data based on the subset of nodes, the document content data being included in the particular page of the first document file and associated with the document structure data included in the subset of nodes;
generating, using the thread, a first editable data element for a first node in the subset of nodes, the first editable data element including first document content data associated with first document structure data of the first node, wherein the first editable data element has a particular hierarchical relationship with a second editable data element for a second node in the subset of nodes;
generating, using the thread, a second document file that includes the first editable data element and the second editable data element having the particular hierarchical relationship; and
providing the second document file to an additional computing system that is configured to display the first editable data element and the second editable data element in a visual arrangement that is based on the particular hierarchical relationship.

14. The system of claim 13, wherein the thread is included in a group of threads executable by the particular memory component,
the operations further comprising:
allocating, to each additional thread in the group of threads, at least one respective additional subset of nodes included in the shared mapping data object, the at least one additional subset of nodes respectively associated with an additional particular page of the first document file;
generating, using the each additional thread in the group of threads, at least one respective additional second document file that includes at least one additional editable data object including additional document content data associated with additional document structure data of the respective additional subset of nodes; and
generating a combined document file that includes the second document file generated using the thread and the at least one respective additional second document file generated using the each additional thread in the group of threads,
wherein providing the second document file to the additional computing system includes providing the combined document file.

15. The system of claim 14, the operations further comprising:
identifying a first quantity of available threads in the group of threads; and
identifying a second quantity of pages in the first document file, wherein the particular page is included in the second quantity of pages,
wherein allocating, to the thread, the subset of nodes associated with the particular page and allocating, to the each additional thread in the group of threads, the at least one respective additional subset of nodes associated with the additional particular page are based on the first quantity of available threads and the second quantity of pages.

16. The system of claim 13, the operations further comprising:
responsive to determining that the first node is associated with a first element tag that describes a non-editable text data element, generating a text frame data element that is included in the first document structure data of the first node, wherein generating the shared mapping data object comprises generating the text frame data element;
responsive to determining, using the thread, that the first document structure data includes the text frame data element:
extracting, using the thread, the first document content data from the non-editable text data element described by the first element tag; and
modifying, using the thread, the first editable data element to include the text frame data element and the first document content data, wherein the thread determines a text arrangement of the first document content data within the text frame data element based on the first document structure data,
wherein generating the second document file further comprises determining, using the thread, that the text frame data element has the particular hierarchical relationship with second document content data included in the second editable data element,
wherein the visual arrangement displayed by the additional computing system includes the text arrangement of the first document content data within the text frame data element.

17. A non-transitory computer-readable medium embodying program code for generating a document file, the program code comprising instructions which, when executed by a processor, cause the processor to perform operations comprising:
receiving a first document file and a set of element tags, wherein the set of element tags describes non-editable data elements included in the first document file;
based on the set of element tags, generating a shared mapping data object, in which each node of the shared mapping data object includes at least one of a) document structure data extracted from the non-editable data elements described by the set of element tags and b) memory location data indicating a memory location of the extracted document structure data;
allocating, to a thread implemented via a memory component controlled by the processor, a subset of nodes included in the shared mapping data object, the subset of nodes associated with a particular page of the first document file;
identifying, using the thread, document content data based on the subset of nodes, the document content data being included in the particular page of the first document file and associated with the document structure data included in the subset of nodes;
generating, using the thread, a first editable data element for a first node in the subset of nodes, the first editable data element including first document content data associated with first document structure data of the first node, wherein the first editable data element has a particular hierarchical relationship with a second editable data element for a second node in the subset of nodes;
generating, using the thread, a second document file that includes the first editable data element and the second editable data element having the particular hierarchical relationship; and
providing the second document file to an additional computing system that is configured to display the first editable data element and the second editable data element in a visual arrangement that is based on the particular hierarchical relationship.

18. The system of claim 17, wherein the thread is included in a group of threads executable by the memory component,
the operations further comprising:
allocating, to each additional thread in the group of threads, at least one respective additional subset of nodes included in the shared mapping data object, the at least one additional subset of nodes respectively associated with an additional particular page of the first document file;
generating, using the each additional thread in the group of threads, at least one respective additional second document file that includes at least one additional editable data object including additional document content data associated with additional document structure data of the respective additional subset of nodes; and
generating a combined document file that includes the second document file generated using the thread and the at least one respective additional second document file generated using the each additional thread in the group of threads,
wherein providing the second document file to the additional computing system includes providing the combined document file.

19. The system of claim 18, the operations further comprising:
identifying a first quantity of available threads in the group of threads; and
identifying a second quantity of pages in the first document file, wherein the particular page is included in the second quantity of pages,
wherein allocating, to the thread, the subset of nodes associated with the particular page and allocating, to the each additional thread in the group of threads, the at least one respective additional subset of nodes associated with the additional particular page are based on the first quantity of available threads and the second quantity of pages.

20. The system of claim 17, the operations further comprising:
responsive to determining that the first node is associated with a first element tag that describes a non-editable image data element, determining, using the thread, image identification data that describes the non-editable image data element;
comparing, using the thread, the image identification data to additional image identification data stored in the shared mapping data object;
responsive to determining that the image identification data matches the additional image identification data stored in the shared mapping data object, performing, using the thread:
i) accessing stored image data identified by the additional image identification data, and
ii) modifying the first document content data to indicate the stored image data; and
modifying, using the thread, the first editable data element to include the first document content data, wherein the thread determines an image arrangement of the first document content data based on the first document structure data.
